(19) United States
(12) Patent Application Publication
(10) Pub. No.: US 2010/0013577 A1
(43) Pub. Date: Jan. 21, 2010

(54) BANDPASS FILTER, WIRELESS COMMUNICATION MODULE AND WIRELESS COMMUNICATION DEVICE

(75) Inventors: Takanori KUBO, Kirishima (JP); Hiromichi Yoshikawa, Kirishima-shi (JP)

Correspondence Address: BIRCH STEWART KOLASCH & BIRCH, PO BOX 747, FALLS CHURCH, VA, 22040-0747, US

(73) Assignee: KYOCERA CORPORATION, Kyoto-Shi (JP)

(21) Appl. No.: 12/567,693

(22) Filed: Sep. 25, 2009

Related U.S. Application Data
(63) Continuation-in-part of application No. PCT/JP2008/053701, filed on Feb. 29, 2008.

(30) Foreign Application Priority Data
Mar. 27, 2007 (JP) 2007-082459
Sep. 27, 2007 (JP) 2007-251575

(51) Int. Cl. H01P 3/08

(52) U.S. Cl. 333/204

(57) ABSTRACT

A bandpass filter for a wide frequency band such as UWB is disclosed. The bandpass filter can receive a pair of signals, namely a balanced signal, and output a pair of signals. The bandpass filter comprises a plurality of ½ wavelength resonance electrodes, a plurality of ¼ wavelength resonance electrodes and a plurality of coupling electrodes. A transmission characteristic of the bandpass filter having flat and low loss over the entire region of the broad pass band can be achieved.

### CROSS-REFERENCE TO RELATED APPLICATION

The present application is a continuation in part based on PCT Application No. JP2008/053701, filed on Feb. 29, 2008, which claims the benefit of Japanese Application No. 2007-082459, filed on Mar. 27, 2007, and Japanese Application No. 2007-251575, filed on Sep. 27, 2007 both entitled “BANDPASS FILTER, RADIO COMMUNICATION MODULE AND RADIO COMMUNICATION DEVICE USING SAME”. The contents of which are incorporated by reference herein in their entirety.

### FIELD OF THE INVENTION

Embodiments of the present invention relate generally to bandpass filters, and more particularly relate to a bandpass filter for a wide frequency band.

### BACKGROUND

In recent years, an Ultra Wide Band (UWB) has drawn attention as a new communication means. UWB transmits amounts of data using a broad frequency band over a short distance such as 10 m or 33 feets. A frequency band of 3.1 to 10.6 GHz, for example, is subjected to use for UWB according to the rule of U.S. FCC (Federal Communication Commission). As such, a feature of UWB is to utilize a broad frequency band. Japan and the ITU-R have a plan to introduce standards separated into a low band of about 3.1 to 4.7 GHz and a high band of about 6 GHz to 10.6 GHz to avoid a band of 5.3 GHz that is used in the IEEE802.11a standard. Accordingly, a low band filter requires the characteristic of being abruptly attenuated at 2.5 GHz and 5.3 GHz.

### SUMMARY

A bandpass filter for a wide frequency band such as UWB is disclosed. The bandpass filter can receive a pair of signals, namely a balanced signal, and output a pair of signals. A transmission characteristic of the bandpass filter having flat and low loss over the entire region of the broad pass band can be achieved.

A first embodiment comprises a bandpass filter. The bandpass filter comprises a ground electrode on or in the laminate, a first ½ wavelength resonance electrode and a second ½ wavelength resonance electrode, a first ¼ wavelength resonance electrode, a second ¼ wavelength resonance electrode, a first input coupling electrode, a second input coupling electrode, a first output coupling electrode and a second output coupling electrode. The laminate comprises a plurality of dielectric layers. The a first ½ wavelength resonance electrode and a second ½ wavelength resonance electrode in a first inter-layer portion of the laminate are arranged in parallel with each other, and each has a strip shape. The a first ¼ wavelength resonance electrode is located between the first ½ wavelength resonance electrode and the second ½ wavelength resonance electrode in the first inter-layer portion of the laminate, has a strip shape, comprises a ground end and an open end, is parallel to a first half portion of the first ½ wavelength resonance electrode and a first half portion of the second ½ wavelength resonance electrode, and is sandwiched by the first half portion of the first ½ wavelength resonance electrode and the first half portion of the second ½ wavelength resonance electrode. The second ¼ wavelength resonance electrode is located between the first ½ wavelength resonance electrode and the second ½ wavelength resonance electrode in the first inter-layer portion of the laminate, has a strip shape, comprises a ground end and an open end, parallel to a second half portion of the first ½ wavelength resonance electrode and a second half portion of the second ½ wavelength resonance electrode, and is sandwiched by the second half portion of the first ½ wavelength resonance electrode and the second half portion of the second ½ wavelength resonance electrode. The first input coupling electrode is in a second inter-layer portion of the laminate has a strip shape, and faces the first half portion of the first ½ wavelength resonance electrode. The second input coupling electrode is in the second inter-layer portion of the laminate, and has a strip shape, facing the second half portion of the first ½ wavelength resonance electrode.

A second embodiment comprises a bandpass filter. The bandpass filter comprises a laminate, a ground electrode on or in the laminate, a first ½ wavelength resonance electrode, a second ½ wavelength resonance electrode, a first ¼ wavelength resonance electrode, a second ¼ wavelength resonance electrode, a third ¼ wavelength resonance electrode, a fourth ¼ wavelength resonance electrode, a first coupling electrode, a second coupling electrode, a third coupling electrode, a fourth coupling electrode and resonant electrode coupling conductor. The laminate comprises a plurality of dielectric layers. The a first ½ wavelength resonance electrode and a second ½ wavelength resonance electrode in a first inter-layer portion of the laminate are arranged in parallel with each other, and each has a strip shape and each comprises a first half portion including a first open end and a second half portion including a second open end. The first ¼ wavelength resonance electrode is located between the first ½ wavelength resonance electrode and the second ½ wavelength resonance electrode in the first inter-layer portion of the laminate, has a strip shape, and faces and is electromagnetically coupled to both the first half portion of the first ½ wavelength resonance electrode and the first half portion of the second ½ wavelength resonance electrode. The first ¼ wavelength resonance electrode comprises a first ground end and a third open end. The first ground end is closer to the first end of the first ½ wavelength resonance electrode and the first end of the second ½ wavelength resonance electrode than the third open end. The second ¼ wavelength resonance electrode is located between the first ½ wavelength resonance electrode and the second ½ wavelength resonance electrode in the first inter-layer portion of the laminate, has a strip shape, and faces and is electromagnetically coupled to both the second half portion of the first ½ wavelength resonance electrode and the second half portion of the second ½ wavelength resonance electrode. The second ¼ wavelength resonance electrode comprises a second ground end and a fourth open end. The second ground end is closer to the second end of the first ½ wavelength resonance electrode and the second end of the second ½ wavelength resonance electrode than the fourth open end. The third ¼ wavelength resonance electrode in the first inter-layer portion of the laminate is located at the other side of the first ¼ wavelength resonance electrode with respect to the first ½ wavelength resonance electrode, has a strip shape, and faces and is electromagnetically coupled to the first half portion of the first ½ wavelength resonance electrode. The third ¼ wavelength resonance electrode comprises a third ground end and a fifth open end. The third ground end is closer to the first end of the first ½ wavelength resonance electrode than the fifth open end. The fourth ¼ wavelength resonance electrode in the first inter-layer portion of the laminate is located at the other side of the second ¼ wavelength resonance electrode with respect to the first ½ wavelength resonance electrode, has a strip shape, and faces and is electromagnetically coupled to the second half portion of the first ½ wavelength resonance electrode. The fourth ¼ wavelength resonance electrode comprises a fourth ground end and a sixth open end, wherein the fourth ground end is closer to the second end of the second ½ wavelength resonance electrode than the sixth open end. The first coupling electrode in a second inter-layer portion of the laminate has a strip shape, faces the third ¼ wavelength resonance electrode, and comprises a first connection point which faces a part of a half portion of the first half portion of the first ½ wavelength resonance electrode at the open end side. The second coupling electrode in the second inter-layer portion has a strip shape, faces the fourth ¼ wavelength resonance electrode, and comprises a second connection point which faces a part of a half portion of the second half portion of the first ½ wavelength resonance electrode at the open end side. The third coupling electrode in the second inter-layer portion has a strip shape, faces the first half portion of the second ½ wavelength resonance electrode, and comprises a third connection point which faces a part of a half portion of the first half portion of the second ½ wavelength resonance electrode at the open end side. The fourth coupling electrode in the second inter-layer portion has a strip shape, face the second half portion of the second ½ wavelength resonance electrode, and comprises a fourth connection point which faces a part of a half portion of the second half portion of the second ½ wavelength resonance electrode at the open end side. The resonant electrode coupling conductor is in the third inter-layer portion of the laminate which is the opposite side of the second inter-layer portion with respect to the first inter-layer portion. The resonant electrode coupling conductor has a strip shape. The resonant electrode coupling conductor comprises a first coupling portion, a second coupling portion and a third coupling portion. The first coupling portion comprises a first end, which is connected to ground potential near the ground end of the third ¼ wavelength resonance electrode, and faces and is electromagnetically coupled to a part of a half portion of the third ¼ wavelength resonance electrode at the ground end side. The second coupling portion comprises a second end, which is connected to ground potential near the ground end of the fourth ¼ wavelength resonance electrode, and faces and is electromagnetically coupled to a part of a half portion of the fourth ¼ wavelength resonance electrode at the ground end side. The third coupling portion faces and electromagnetically coupled to at least a center part of the second ½ wavelength resonance electrode.

A third embodiment comprises a high frequency module. The high frequency module comprises a RF module comprising a bandpass filter mentioned above, and a base band module connected to the RF module.

A fourth embodiment comprises a radio communication device. The radio communication device comprises a RF module comprising a bandpass filter mentioned above, a base band module connected to the RF module and an antenna connected to the bandpass filter.

### BRIEF DESCRIPTION OF THE DRAWINGS

Embodiments of the present invention are hereinafter described in conjunction with the following figures, wherein like numerals denote like elements. The figures are provided for illustration and depict exemplary embodiments of the invention. The figures are provided to facilitate understanding of the invention without limiting the breadth, scope, scale, or applicability of the invention. The drawings are not necessarily made to scale.

FIG. 1 is a perspective view schematically illustrating the external appearance of a bandpass filter according to one embodiment of the present invention.

FIG. 2 is an exploded perspective view schematically illustrating the bandpass filter shown in FIG. 1.

FIG. 3A is a plan view schematically illustrating an upper surface of the bandpass filter shown in FIG. 1.

FIG. 3B to 3D are plan views schematically illustrating inter-layers of the bandpass filter shown in FIG. 1.

FIG. 3E is a plan view schematically illustrating a bottom lower of the bandpass filter shown in FIG. 1.

FIG. 4 is a cross sectional view taken along the line IV-IV shown in FIG. 1.

FIG. 5 is a perspective view schematically illustrating the external appearance of a bandpass filter according to one embodiment of the present invention.

FIG. 6 is an exploded perspective view schematically illustrating the bandpass filter shown in FIG. 5.

FIG. 7A is a plan view schematically illustrating an upper surface of the bandpass filter shown in FIG. 5.

FIG. 7B to 7D are plan views schematically illustrating inter-layers of the bandpass filter shown in FIG. 5.

FIG. 7E is a plan view schematically illustrating a bottom lower of the bandpass filter shown in FIG. 5.

FIG. 7F is an enlarged plan view of FIG. 7C.

FIG. 8 is a cross sectional view taken along the line VIII-VIII shown in FIG. 5.

FIG. 9 is a perspective view schematically illustrating the external appearance of a bandpass filter according to one embodiment of the present invention.

FIG. 10 is an exploded perspective view schematically illustrating the bandpass filter shown in FIG. 9.

FIG. 11 is an exploded perspective view schematically illustrating the bandpass filter according to one embodiment of the present invention.

FIG. 12 is an exploded perspective view schematically illustrating the bandpass filter according to one embodiment of the present invention.

FIG. 13 is a block diagram illustrating a constructional example of a wireless communication device using the bandpass filter according to one embodiment of the present invention.

FIG. 14 is a graph showing a result of simulation regarding an electrical characteristic of the bandpass filter shown in FIGS. 5 to 8.

FIG. 15 is a graph showing a result of simulation regarding an electrical characteristic of the bandpass filter shown in FIG. 12.

FIG. 16 is a graph showing a result of simulation regarding an electrical characteristic of an existing bandpass filter.

### DETAILED DESCRIPTION OF EXEMPLARY EMBODIMENTS

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the invention. Furthermore, there is no intention to be bound by any expressed or implied theory presented in the preceding technical field, background, brief summary or the following detailed description. The present disclosure should be accorded scope consistent with the claims, and not limited to the examples described and shown herein.

Embodiments of the disclosure are described herein in the context of practical non-limiting applications, namely, bandpass filters. Embodiments of the disclosure, however, are not limited to such bandpass filters, and the techniques described herein may also be utilized in other filter applications. For example, embodiments are not limited to a wide bandpass filter and may be applicable to a high frequency module, radio communication device, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

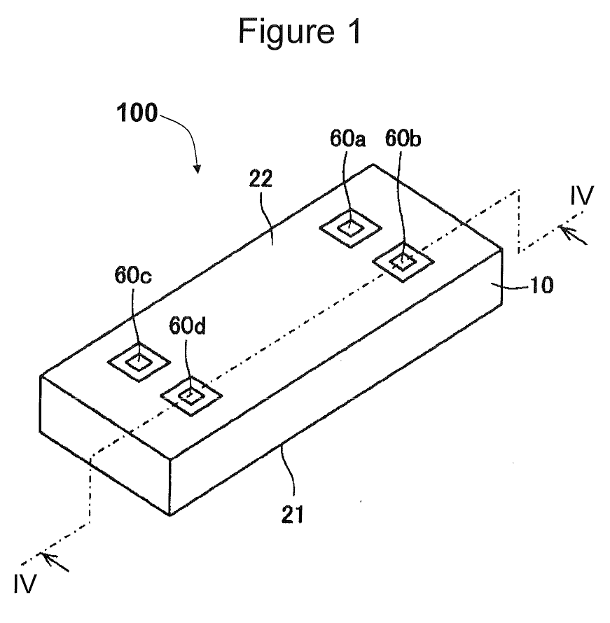

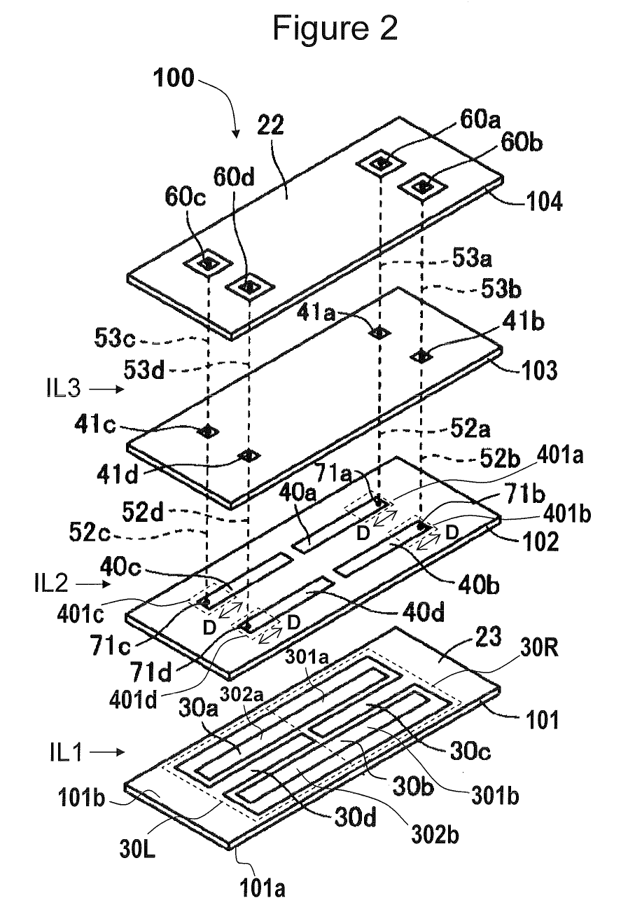

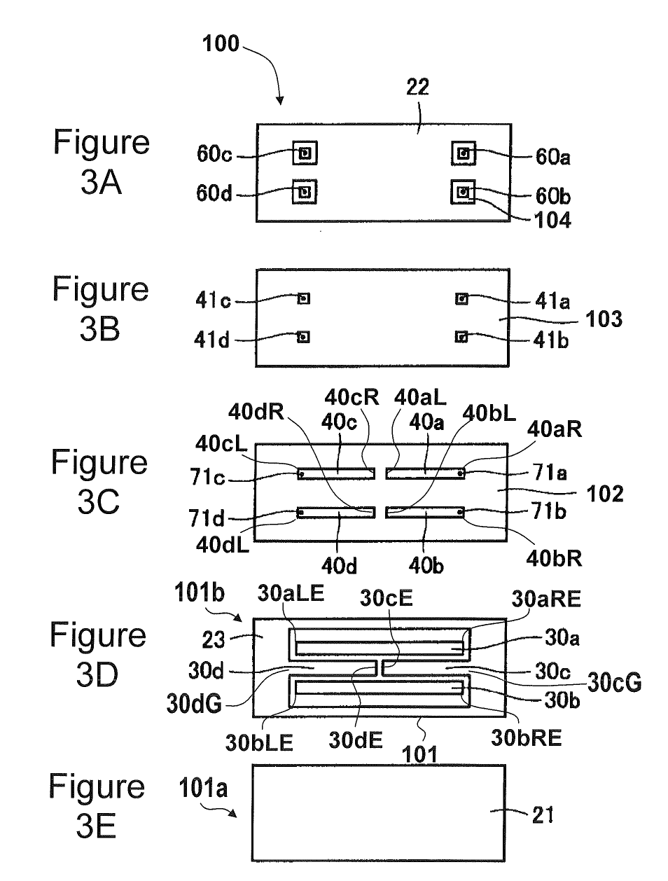

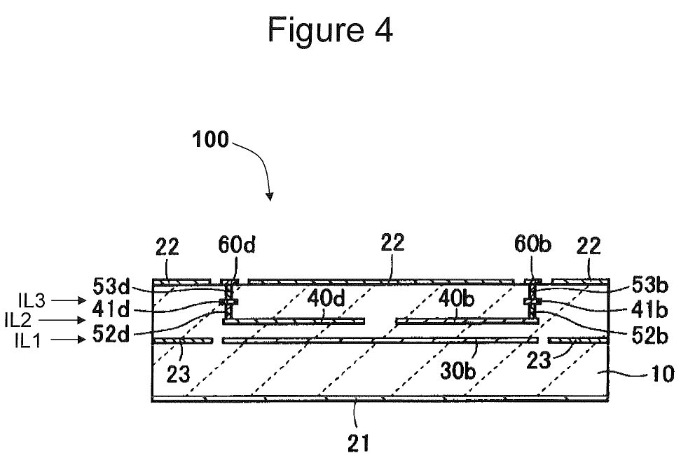

FIG. 1 is a perspective view schematically illustrating the external appearance of a bandpass filter according to one embodiment of the present invention. FIG. 2 is an exploded perspective view schematically illustrating the bandpass filter shown in FIG. 1. FIGS. 3A to 3E are plan views schematically illustrating an upper surface, a lower surface and inter-layers of the bandpass filter shown in FIG. 1. FIG. 4 is a cross sectional view taken along the line IV-IV shown in FIG. 1.

The bandpass filter 100 according to one embodiment of the present invention comprises a laminate 10. The laminate 10 comprises a plurality of dielectric layers 101, 102, 103 and 104 which are stacked. In other words, the laminate 10 comprises a plurality of inter-layers IL1, IL2 and IL3 between two of the dielectric layers 101 to 104. The number of the dielectric layers is not limited for the present invention. Some of dielectric layers may be shown and the other may not be shown in the figures.

The bandpass filter 100 further comprises a first ground electrode 21, a second ground electrode 22. In addition, the bandpass filter 100 may comprise an annular ground electrode 23.

The first ground electrode 21 is located on the bottom surface of the laminate 10. In other words, the first ground electrode 21 is disposed on a lower surface 101a of the dielectric layer 101. The first ground electrode 21 can, without limitation, cover the entire surface of the lower surface 101a. In an embodiment, one or more additional dielectric layers (not shown) may be arranged under the first ground electrode 21 to sandwich the first ground electrode 21 with the dielectric layer 101.

The second ground electrode 22 is located on the top surface of the laminate 10. In other words, the second ground electrode 22 is disposed on an upper surface of the dielectric layer 104. In an embodiment, one or more additional dielectric layers (not shown) may be attached on the second ground electrode 22 to sandwich the second ground electrode 21 with the dielectric layer 104. The second ground electrode 22 can, without limitation, cover the entire surface of the upper surface of the dielectric layer 104 except a first input terminal electrode 60a, a first output stage electrode 60b, a second input terminal electrode 60c, a second output terminal electrode 60d and their peripheries which are located on the dielectric layer 104 and is described in details below.

The bandpass filter 100 further comprises an input resonance electrode 30a (first ½ wavelength resonance electrode), an output resonance electrode 30b (second ½ wavelength resonance electrode), a first central resonance electrode 30c (first ¼ wavelength resonance electrode) and a second central resonance electrode 30d (second ¼ wavelength resonance electrode). Hereinafter, a group of the input resonance electrode 30a, the output resonance electrode 30b, the first central resonance electrode 30c and the second central resonance electrode 30d may be called as resonance electrodes 30a, 30b, 30c and 30d. Each of the resonance electrodes 30a, 30b, 30c and 30d may have strip shapes.

The resonance electrodes 30a, 30b, 30c and 30d are located on upper surface 101b of the dielectric layer 101 of the laminate 10. This surface may be referred to a first inter-layer portion IL1 of the laminate 10.

Both of the first ground electrode 21 and the second ground electrode 22 are connected to the ground potential, and therefore, the first ground electrode 21 and the second ground electrode 22 constitute a strip line resonator along with the resonance electrodes 30a, 30b, 30c and 30d.

The bandpass filter 100 further comprises a first input coupling electrode 40a (or a first coupling electrode), a first output coupling electrode 40b (or a second coupling electrode), a second input coupling electrode 40c (or a third coupling electrode) and a second output coupling electrode 40d (or a fourth coupling electrode). Hereinafter, a group of the first input coupling electrode 40a, the first output coupling electrode 40b, the second input coupling electrode 40c and the second output coupling electrode 40d may be called as coupling electrodes 40a, 40b, 40c and 40d. These coupling electrodes can serve as terminal electrodes connecting to terminal electrodes via penetration conductors. Each of the coupling electrodes 40a, 40b, 40c and 40d may have strip shapes.

The coupling electrodes 40a, 40b, 40c and 40d are located on the surface of a dielectric layer 102 of the laminate 10. This surface may be referred to a second inter-layer portion IL2 of the laminate 10.

The bandpass filter 100 may comprise a first connecting electrode 41a, a second connecting electrode 41b, a third connecting electrode 41c and a fourth connecting electrode 41d. Hereinafter, a group of the first connecting electrode 41a, the second connecting electrode 41b, the third connecting electrode 41c and the fourth connecting electrode 40d may be called as connecting electrodes 41a, 41b, 41c and 41d.

The connecting electrodes 41a, 41b, 41c and 41d are located on the surface of a dielectric layer 103 of the laminate 10. This surface may be referred to a third inter-layer portion IL3 of the laminate.

The first connecting electrode 41a is connected to the first input coupling electrode 40a by a fifth penetration conductor 52a which penetrates the dielectric layer 103. The second connecting electrode 41b is connected to the first output coupling electrode 40b by a sixth penetration conductor 52a which penetrates the dielectric layer 103. The third connecting electrode 41c is connected to the second input coupling electrode 40c by a seventh penetration conductor 52c which penetrates the dielectric layer 103. The fourth connecting electrode 41d is connected to the second output coupling electrode 40d by a eighth penetration conductor 52d which penetrates the dielectric layer 103.

The bandpass filter 100 may comprise a first input terminal electrode 60a, a first output terminal electrode 60b, a second input terminal 60c, and a second output terminal electrode 60d. Hereinafter, a group of the first input terminal electrode 60a, the first output terminal electrode 60b, the second input terminal 60c and the second output terminal electrode 60d may be called as terminal electrodes 60a, 60b, 60c and 60d. The terminal electrodes 60a, 60b, 60c and 60d are located on the top surface of the laminate 10. In other words, the terminal electrodes are located on the upper surface of a dielectric layer 104.

The terminal electrodes 60a, 60b, 60c and 60d face the connecting electrodes 41a, 41b, 41c and 41d, respectively. The first input terminal electrode 60a is connected to the first connecting electrode 41a by a first penetration conductor 53a which penetrates the dielectric layer 104. The second input terminal electrode 60c is connected to the third connecting electrode 41c by a third penetration conductor 53c which penetrates the dielectric layer 104. The first output terminal electrode 60b is connected to the second connecting electrode 41b by a second penetration conductor 53b which penetrates the dielectric layer 104. The second output terminal electrode 60d is connected to the fourth connecting electrode 41d by a fourth penetration conductor 53d which penetrates the dielectric layer 104.

Each of the input resonance electrode 30a and the output resonance electrodes 30b can serve as a ½ wavelength resonator. Each of the input and output resonance electrodes 30a and 30b is equivalent to two resonance electrodes, each of which serves as a ¼ wavelength resonator, arranged in one direction.

The input resonance electrode 30a comprises two open ends, a right end 30aRE and a left end 30aLE. The output resonance electrode 30b comprises two open ends, a right end 30bRE and a left end 30bLE. The first central resonance electrode 30c comprises two ends, an open end 30cE and a first grand end 30cG. The first grand end 30cG is connected to the annular ground electrode 23. In the same manner, the second central resonance electrode 30d comprises two ends, an open end 30dE and a second grand end 30dG. The second grand 30dG is connected to the annular ground electrode 23. The second open end 30dE faces the first open end 30cE of the first central resonance electrode 30c on their sides. That is, one end (ground end 30cG or 30dG) of each of the central resonance electrodes 30d and 30d is connected to the annular ground electrode 23, i.e., to the ground potential.

The length of each of the resonance electrodes 30a, 30b, 30c and 30d may be, without limitation, about 2 to 6 mm if the relative dielectric constant of the dielectric layers 101, 102, 103 and 104 is set on the order of 10 by setting the center frequency as 4 GHz.

Thus, the right half portion 301a of the input resonance electrode 30a corresponding to ¼ wavelength and the right half portion 301b of the output resonance electrode 30b corresponding to ¼ wave length are operable to be coupled electromagnetically (edge coupled) with the first central resonance electrode 30c which is located between the input resonance electrode 30a and the output resonance electrode 30b.

In the same manner, the left half portion 302a of the resonance electrode 30a corresponding to ¼ wave length and the left half portion 302b of the output resonance electrode 30b corresponding to ¼ wavelength are operable to be coupled electromagnetically (edge coupling) with the second central resonance electrode 30d which is located between the input resonance electrode 30a and the output resonance electrode 30b.

Accordingly, the right half portion 301a of the first resonance electrode 30a, the right half portion 301b of the output resonance electrode 30b and the first central resonance electrode 30c are operable to be coupled to each other in an inter-digital type. In the same manner, the left half portion 302a of the resonance electrode 30a, the left half portion 302b of the output resonance electrode 30b and the second central resonance electrode 30d are coupled to each other in an inter-digital type. Such a coupling is storing because a coupling by magnetic fields is added to a coupling by electric fields.

As the interval between the central resonance electrodes 30c, 30d and the input resonance electrodes 30a becomes narrower, or the interval between the central resonance electrodes 30c, 30d and the output resonance electrodes 30b becomes narrower, the coupling may be stronger. However, if the interval becomes too narrow, the difficulty in manufacturing the resonance electrodes 30a, 30b, 30c and 30d may increase. Accordingly, the interval between the resonance electrodes 30a, 30b, and 30c is set, without limitation, about 0.05 to 0.5 mm.

As such, since the resonance electrodes 30a, 30b, 30c and 30d are not only edge-coupled but also coupled to each other in the inter-digital type, the frequency interval between resonance frequencies in each resonance mode is adapted to be appropriate to gain a broad pass band width on the order of 40% by the relative bandwidth which is well in excess of the region that can be realized by the conventional filter using the ¼ wavelength resonator and is appropriate as a bandpass filter for UWB.

In addition, our review showed that it is not preferable to make a coupling between the resonance electrodes 30a, 30b, 30c and 30d in an inter-digital type and make a broad-side coupling therebetween as well because the coupling becomes too strong to achieve the pass band width of about 40% by the relative bandwidth.

The input coupling electrodes 40a, 40c which are located on the upper surface of the dielectric layer 102, face the input resonance electrode 30a of the input stage on the dielectric layer 101, and therefore are operable to be coupled to the input resonance electrode 30a.

In other words, the input coupling electrode 40a faces the right half portion 301a of the first resonance electrode 30a in the right half portion 30R of the resonance electrode region, and therefore, is operable to be electromagnetically coupled to the right half portion 301a of the first resonance electrode 30a. In the same manner, the output coupling electrode 40c faces the left half portion 302a of the first resonance electrode 30a in the left half portion 30L of the resonance electrode region, and therefore, is operable to be electromagnetically coupled to the left half portion 302b of the first resonance electrode 30a.

Accordingly, the input coupling electrode 40a and the right half portion 301a of the first resonance electrode 30a in the right half portion 30R of the resonance electrode region of the input stage are broad-side coupled to each other, and therefore, the coupling becomes stronger than the edge-coupling. Also, the input coupling electrode 40c and the left half portion 302a of the first resonance electrode 30a in the left half portion 30L of the resonance electrode region of the input stage are broad-side coupled to each other, and therefore, the coupling becomes stronger than the edge-coupling.

Further, the first input coupling electrode 40a is connected to the first input terminal electrode 60a on the dielectric layer 104 by penetration conductors 52a, 53a via the first connecting electrode 41a, while the second input coupling electrode 40c is connected to the second input terminal electrode 60c on the dielectric layer 104 by penetration conductors 52c, 53c via the third connecting electrode 41c.

The first input coupling electrode 40a comprises a first contact point 71a which is connected to the second penetration conductor 52a. The first contact point 71a may be located at a region 401a which has the length D of less than ¼ of the length of the input resonance electrode 30a from the right end 40aR of the first input coupling electrode 40a. The first contact point 71a faces a point near the right end 30aRE of the input resonance electrode 30a.

The second input coupling electrode 40c comprises a third contact point 71c which is connected to the second penetration conductor 52c. The third contact point 71c may be located at a region 401c which has the length D of less than ¼ of the length of the input resonance electrode 30a from the left end 40aL of the second input coupling electrode 40c. The third contact point 71c faces the left end 30aLE of the input resonance electrode 30a.

The first input coupling electrode 40a comprises an end 40aL which is the open end located at the other side of the first contact point 71a. The second input coupling electrode 40c comprises an end 40cR which is the open end located at the other side of the third contact point 71c. The ends 40aL, 403E are separated and face each other.

A balanced type electrical signal (or a pair of electrical signals comprising a first waveform signal and a second waveform signal which are opposite phase with each other) inputted from an external circuit is supplied not only to the first input coupling electrode 40a through the first contact point 71a but also to the second input coupling electrode 40c through the third contact point 71c. Therefore, the input coupling electrodes 40a, 40c and the resonance electrode 30a, 30c of the input stage are operable to be coupled to each other in an inter-digital type, respectively, and therefore, a coupling by magnetic fields are added to a coupling by electric fields, so that the coupling becomes stronger than the comb-line type coupling alone or capacitive coupling alone.

As such, since the first input coupling electrode 40a can be not only broad-side coupled but also coupled in an inter-digital type with the right half portion 301a of the input resonance electrode 30a of the input stage, the input coupling electrode 40a ends up to be coupled to the right half portion 301a of the input resonance electrode 30a of the input stage strongly. In the same manner, the second input coupling electrode 40C can be coupled to the left half portion 302a of the input resonance electrode 30a of the input state strongly.

Similarly, the output coupling electrodes 40b, 40d are located on the upper surface of the dielectric layer 102 while the input and output resonance electrodes 30a, 30b is located on the upper surface of the dielectric layer 101, face the output resonance electrode 30b of the output stage, and can be coupled to the output resonance electrode 30b.

In other words, the output coupling electrode 40b faces the right half portion 301b of the output resonance electrode 30b in right half portion 30R of the resonance electrode region, and therefore, is operable to be electromagnetically coupled to the right half portion 301b of the second resonance electrodes 30b. In the same manner, the output coupling electrode 40d faces the left half portion 302b of the output resonance electrode 30b in the left half portion 30L of the resonance electrode region, and therefore, can be electromagnetically coupled to the left half portion 302b of the output resonance electrodes 30b.

Accordingly, the first output coupling electrode 40b and the right half portion 301b of the output resonance electrode 30b in the right half portion 30R of the resonance electrode region of the input stage are broad-side coupled to each other, and therefore, the coupling becomes stronger than the edge-coupling. Also, the second output coupling electrode 40c and the left half portion 302b of the output resonance electrode 30b in the left half portion 30L of the resonance electrode region of the output stage are broad-side coupled to each other, and therefore, the coupling becomes stronger than the edge-coupling.

Further, the first output coupling electrode 40b is connected to the first output terminal electrode 60b on the dielectric layer 104 by the penetration conductors 52b, 53b via the second connecting electrode 41b, while the second output coupling electrode 40d is connected to the second output terminal electrode 60d on the dielectric layer 104 by penetration conductors 52d, 53d via the fourth connecting electrode 41d.

The first output coupling electrode 40b comprises a second contact point 71c which is connected to the second penetration conductor 52b. The second contact point 71b may be located at a region 401b which has the length D of less than ¼ of the length of the output resonance electrode 30b from the right end of the first output coupling electrode 40b. The second contact point 71b faces the right end of the output resonance electrode 30b.

The second output coupling electrode 40d comprises a second contact point 71c which is connected to the fourth penetration conductor 52d. The second contact point 71d may be located at a region 401d which has the length D of less than ¼ of the length of the output resonance electrode 30b from the left end of the second output coupling electrode 40d. The fourth contact point 71d faces the left end of the output resonance electrode 30b.

The first output coupling electrode 40b comprises an end 40bR which is the open end located at the other side of the second contact point 71b. The second output coupling electrode 40d comprises an end 40dR which is the open end located at the other side of the fourth contact point 71d. The ends 40bR, 40bL are separated and face each other.

An electrical signal outputting to an external circuit is drawn not only from a second contact point 71b but also from the fourth contact point 71d.

Therefore, the output coupling electrode 40b and the resonance electrode 30b of the output stage are operable to be coupled to each other in the inter-digital type, respectively, and therefore, a coupling by magnetic fields are added to a coupling by electric fields, so that the coupling becomes stronger than the comb line-type coupling alone or capacitive coupling alone.

As such, since the output coupling electrode 40b is not only broad-side coupled but also coupled in an inter-digital type with the resonance electrode 30b of the output stage, the output coupling electrode 40b ends up to be coupled to the resonance electrode 30b of the output stage strongly. In the same manner, the second output coupling electrode 40d can be coupled to the resonance electrode 30b of the output stage strongly.

Since the input coupling electrodes 40a, 40c and the first resonance electrode 30a of the input stage are operable to be coupled to each other strongly and the output coupling electrodes 40b, 40d and the second resonance electrode 30b of the output stage are operable to be coupled to each other strongly, a bandpass filter may be obtained, whose insertion loss is not greatly increased at frequencies located between resonance frequencies in each resonance mode even in the broad pass band width well in excess of the region that may be achieved by the conventional filter using the ¼ wavelength resonator, and which has a flat and low-loss transmission characteristic over the entire region of the broad pass band.

In one embodiment, the shape dimensions of the input coupling electrodes 40a, 40c may be set to be substantially the half portion of the first resonance electrode 30a. In other words, if the input coupling electrodes 40a, 40c are arranged next each other in the same direction, the total shape dimension of the input coupling electrodes 40a, 40c is substantially identical to the first resonance electrode 30a. Similarly, if the output coupling electrodes 40b, 40d are arranged next each other in the same direction, the total shape dimension of the input coupling electrodes 40b, 40d is substantially identical to the second resonance electrode 30b.

As the interval between the input coupling electrodes 40a, 40c and the first resonance electrode 30a of the input stage, and the interval between the output coupling electrodes 40b, 40d and the second resonance electrode 30b of the output stage are smaller, the coupling may become stronger but they may become difficult to be manufactured. Therefore, the intervals are set, without limitation, to about 0.01 to 0.5 mm.

The annular ground electrode 23 having a ring shape is located on the upper surface 101b of the dielectric layer 101 of the laminate 10. The annular ground electrode 23 surrounds resonance electrodes which comprises the input resonance electrodes 30a, the output resonance electrode 30b, the first central resonance electrode 30c and the second central resonance electrode 30d. The annular ground electrode 23 is connected to one end (ground end) of each of the central resonance electrodes 30c and 30c.

Since the annular ground electrode 23 is connected to the ground potential, the first central resonance electrode 30c and the second central resonance electrode 30d which are connected to the annular ground electrode 23 can be connected to the ground potential.

In addition, the annular ground electrode 23 reduces the electromagnetic wave generated by the resonance electrodes 30a, 30b, 30c and 30d to spread out from the filter. This may be effective to reduce the negative effect on other electrical units in a module which comprises a bandpass filter therein.

In one embodiment, the input terminal electrodes 60a, 60c and output terminal electrodes 60b, 60d may be omitted if, for example and without limitation, a bandpass filter is formed inside of a module substrate.

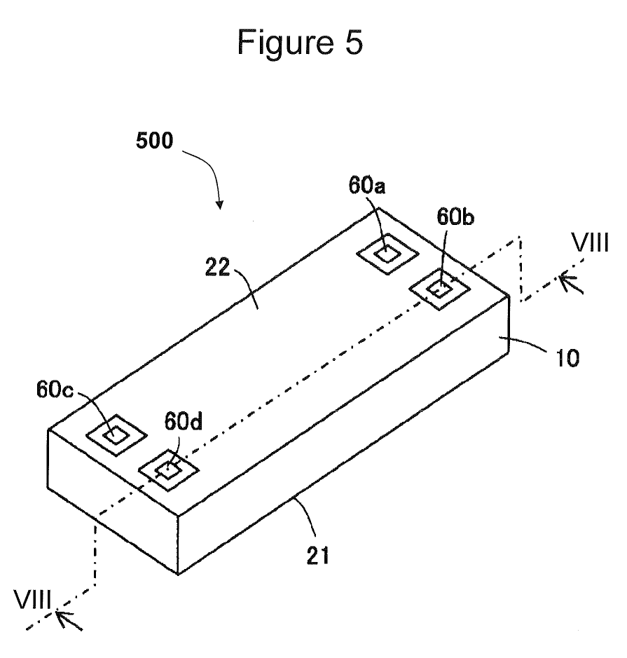

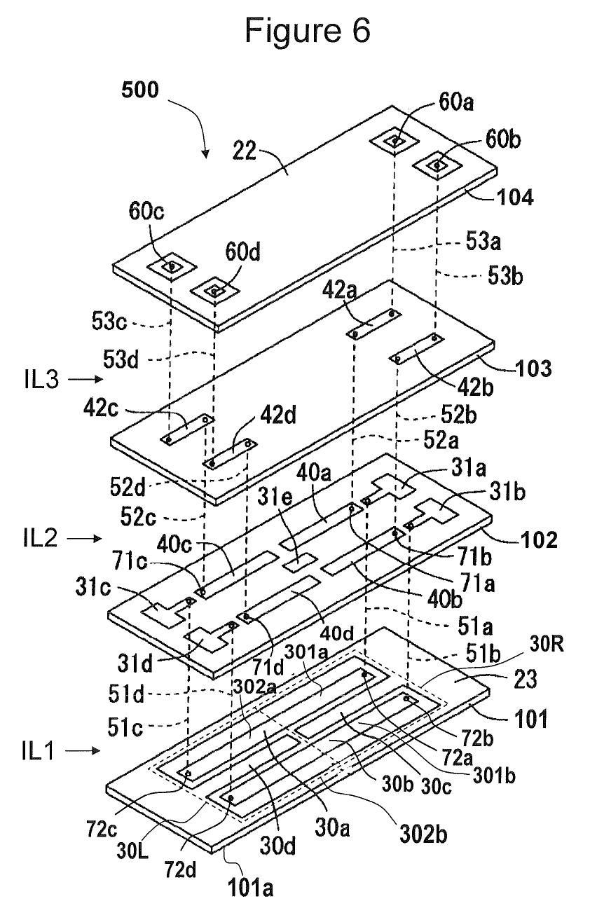

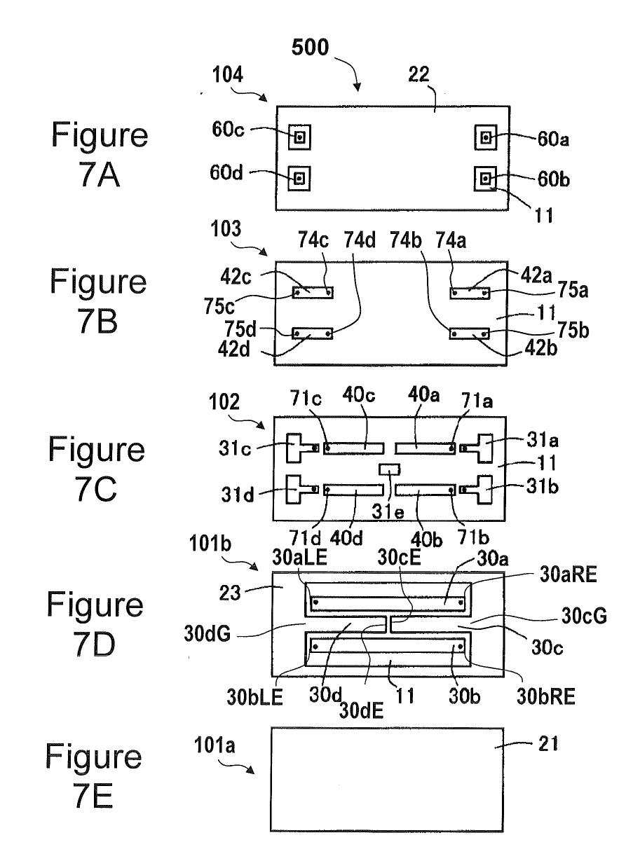

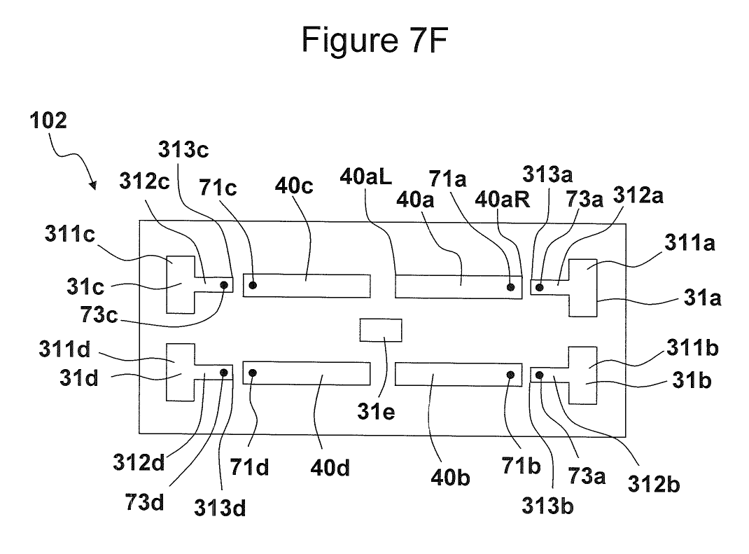

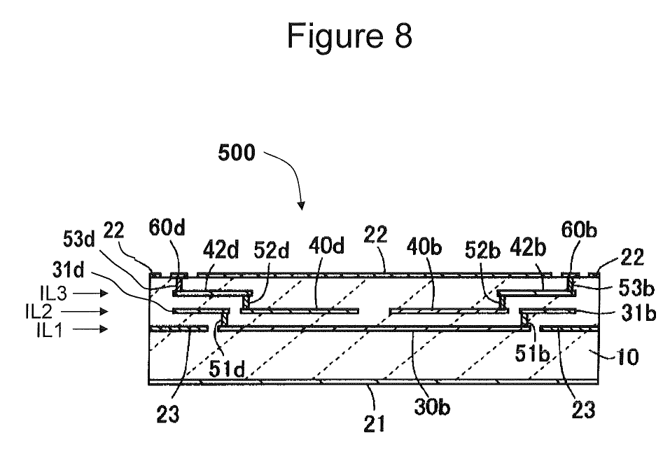

FIG. 5 is a perspective view schematically illustrating the external appearance of a bandpass filter according to an embodiment of the present invention. FIG. 6 is an exploded perspective view schematically illustrating the bandpass filter shown in FIG. 5. FIG. 7A is a plan view schematically illustrating an upper surface of the bandpass filter shown in FIG. 5. FIG. 7B to 7D are plan views schematically illustrating inter-layers of the bandpass filter shown in FIG. 5. FIG. 7E is a plan view schematically illustrating a bottom lower of the bandpass filter shown in FIG. 5. FIG. 7F is an enlarged plan view of FIG. 7C. FIG. 8 is a cross sectional view taken along the line VIII-VIII shown in FIG. 5.

The following descriptions focus on only the differences from the embodiments shown in FIGS. 1 to 4, wherein the same reference numerals refer to the same constitutional elements, and therefore, the repetitive descriptions will be omitted.

In one embodiment, a bandpass filter 500 may comprise auxiliary resonance electrodes and/or auxiliary coupling electrodes. As shown in FIGS. 5 to 8, for example, the bandpass filter may comprise a first auxiliary input resonance electrode 31a, a second auxiliary input resonance electrode 31c, a first auxiliary output resonance electrode 31b and a second auxiliary output resonance electrode 31d on the dielectric layer 102 where the input coupling electrodes 40a, 40c and the output coupling electrodes 40b, 40d are located. In an embodiment, the auxiliary resonance electrodes 31a, 31c, 31b, and 31d can be arranged on the different dielectric layer from the dielectric layer on which the coupling electrodes 40a, 40b, 40c and 40d are located.

Hereinafter, a group or the first auxiliary input resonance electrode 31a, the second auxiliary input resonance electrode 31c, the first auxiliary output resonance electrode 31b and the second auxiliary output resonance electrode 31d may be called as an auxiliary resonance electrodes 31a, 31b, 31c and 31d.

The input resonance electrode 30a comprises a first input contact point 72a near the right end 30aRE thereof and a second input point 72c near the left end 30aLE thereof, and the output resonance electrode 30b comprises a first output contact point 72b near the right end 30bRE thereof and a second output point 72d near the right end 30bLE thereof.

A first auxiliary input resonance electrode 31a comprises a third input contact point 73a which is connected to the first input contact point 72a of the input resonance electrode 30a via a penetration conductor 51a which penetrates the dielectric layer 104. A second auxiliary input resonance electrode 31c comprises a fourth input contact point 73c which is connected to the second input contact point 72c of the input resonance electrode 30a via a penetration conductor 51c which penetrates the dielectric layer 104.

A first auxiliary output resonance electrode 31b comprises a third output contact point 73b which is connected to the first output contact point 72b of the output resonance electrode 30b via a penetration conductor 51b which penetrates the dielectric layer 104. A second auxiliary output resonance electrode 31d comprises a fourth output contact point 73d which is connected to the second output contact point 72d of the output resonance electrode 30d via a penetration conductor 51d which penetrates the dielectric layer 104.

The auxiliary resonance electrodes 31a, 31b, 31c and 31d may have a desired shape such as a triangle, a square, and the like. The auxiliary resonance electrodes 31a, 31b, 31c and 31d can have, for example, “T” shapes as shown in FIGS. 6, 7C and 7F. As shown in FIGS. 6, 7C and 7F, the first auxiliary input resonance electrode 31a comprises a first portion 311a which faces a part of the annular ground electrode 23, and a second portion 312a which comprises an open end 313a. The second portion 312a faces the first input coupling electrode 40a at the side of the first end 313a. The second portion 312a comprises the third input contact point 73a near the open end 313a.

In the same manner, the second auxiliary input resonance electrode 31c comprises a third portion 311c which faces a part of the annular ground electrode 23, and a fourth portion 312c which comprises an open end 313c. The fourth portion 312c faces the second input coupling electrode 40c at the side of the open end 313c. The third portion 312c comprises the fourth input contact point 73c near the open end 313c.

A first auxiliary output resonance electrode 31b comprises a fifth portion 311b which faces a part of the annular ground electrode 23, and a sixth portion 312b which comprises an second end 313b. The sixth portion 312b faces the first output coupling electrode 40b at the side of the third end 313b. The sixth portion 312b comprises the third output contact point 73b near the open end 313b.

The second auxiliary output resonance electrode 31c comprises a seventh portion 311d which faces a part of the annular ground electrode 23, and a eighth portion 312d which comprises an fourth end 313d. The eighth portion 312d faces the second output coupling electrode 40d at the side of the fourth end 313b. The eighth portion 312c comprises the fourth output contact point 73d near the open end 313d.

A bandpass filter 500 may comprise a third ground electrode 31e on the dielectric layer 102. A part of the annular ground electrode 23 may face the first auxiliary output resonance electrode 31b at near the open end 30cE and the second auxiliary output resonance electrode 31d at near the open end 30dE. That is, the third ground electrode 31e is configured to be located such that the third ground electrode 31e faces each end of the first central resonance electrode 30c and the second central resonance electrode 30d, and therefore, the third ground electrode 31e is operable to be electromagnetically coupled to the first central resonance electrode 30c and the second central resonance electrode 30d equally. In such a case, the third ground electrode 31e may be located at a null point, and therefore have a ground potential.

Therefore, the third ground electrode 31e is not necessary to physically connect to a ground electrode as long as the third ground electrode 31e faces each end of the first central resonance electrode 30c and the second central resonance electrode 30d. This configuration is as effective as the configuration where the first auxiliary input resonance electrode 31a, the second auxiliary input resonance electrode 31c, the first auxiliary output resonance electrode 31b, and the second auxiliary output resonance electrode 31d face the annular ground electrode 23. According to the configuration comprising the third ground electrode 31e, the length of the resonance electrodes 30a, 30b, 30c and 30d can be shortened.

Each of the auxiliary resonance electrodes 31a, 31b, and 31c faces a facing area of the annular ground electrode 23. In the facing areas, capacitance is generated between the auxiliary resonance electrodes 31a, 31b, 31c and 31d and the annular ground electrode 23, and also between an area, which face the third ground electrode 31e, of the first central resonance electrode 30c near the one end thereof and an area, which face the third ground electrode 31e, of the second central resonance electrode 30d near the one end thereof, and the third ground electrode 31e. This configuration may shorten the length of the resonance electrodes 30a, 30b, and 30c, thus enabling a small-size bandpass filter.

Considering the dimensions and the capacitance, the facing area may be set, for example, to an area with about 0.01 to 0.3 mm². As the interval between the facing areas is smaller, a stronger coupling may be achieved, however, this makes it uneasy to manufacture the bandpass filter. Therefore, the interval is set, without limitation and for example, to about 0.05 to 0.5 mm.

The number and the arrangement of auxiliary resonance electrodes and ground electrodes are not limited to ones shown in FIGS. 5 to 8. For example, the bandpass filter 500 comprises two auxiliary resonance electrodes, the first auxiliary input resonance electrode 31a and the first auxiliary output resonance electrode 31b. That is, the second auxiliary input resonance electrode 31c and the second auxiliary output resonance electrode 31d can be omitted in an embodiment. Also, the bandpass filter 500 comprises the third ground electrode 31e which faces only the open end 30cE of the first central resonance electrode 30c. In this case, the third ground electrode 31e is not at a null point, and therefore the third ground electrode 31e is connected to a ground potential.

In an embodiment, a bandpass filter may comprise one or more auxiliary input coupling electrodes, and one or more auxiliary output coupling electrodes. Specifically, referring to FIGS. 5 to 8, the bandpass filter 500 further comprise a first auxiliary input coupling electrode 42a (or a first auxiliary coupling electrode), a second auxiliary input coupling electrode 42 c (or a second auxiliary coupling electrode), a first auxiliary output coupling electrode 42b (or a third auxiliary coupling electrode), and a second auxiliary output coupling electrode 42d (or a fourth auxiliary coupling electrode) on the dielectric layer 103 which is one layer above the dielectric layer 103.

The first auxiliary input coupling electrode 42a comprises a first coupling contact point 74a and a first connecting point 75a. The first coupling contact point 74a is connected to the first input contact point 71a via a penetration conductor 52a, and the first connecting point 75a is connected to the first input terminal 60a via a penetration conductor 53a. A part of the first auxiliary input coupling electrode 42a is configured to face the first auxiliary input resonance electrode 31a.

The first auxiliary input coupling electrode 42a connected to the first input coupling electrode 40a and the first auxiliary input resonance electrodes 31a connected to the right half portion 301a of the input resonance electrode 30a are broad-side coupled. In addition, a part of the first auxiliary input coupling electrode 42a faces the first auxiliary input resonance electrode 31a and is connected to the first input terminal electrode 60a at the first connecting point 75a via the penetration conductor 53a. That is, a balanced type electrical signal inputted from an outside circuit is provided to the first input coupled electrode 40a via the first auxiliary input coupling electrode 42a.

Therefore, the coupling (first additional coupling) between the first auxiliary input coupling electrode 42a and the first auxiliary input resonance electrodes 31a is added to the coupling between the first input coupling electrode 40a and the right half portion 301a of the input resonance electrodes 30a, thereby making the overall coupling an inter-digital coupling. Therefore the overall coupling is strong.

Consequently, the coupling mentioned above can have a stronger coupling than that without the first additional coupling or that in a case in which the first auxiliary input coupling electrode 42a is connected to the first input terminal electrode 60a at the first coupling contact point 74a instead of the first connecting point 75a.

The second auxiliary input coupling electrode 42c comprises a second coupling contact point 74c and a second connecting point 75c. The second coupling contact point 74c is connected to the second input contact point 71c via a penetration conductor 52c, and the second connecting point 75c is connected to the second input terminal 60c via a penetration conductor 53c. A part of the second auxiliary input coupling electrode 42c is configured to face the second auxiliary input resonance electrode 31c.

The second auxiliary input coupling electrode 42c connected to the second input coupling electrode 40c and the second auxiliary input resonance electrode 31c connected to the right half portion 302a of the input resonance electrode 30a are broad-side coupled. In addition, a part of the second auxiliary input coupling electrode 42c faces the second auxiliary input resonance electrode 31c and is connected to the first input terminal electrode 60c at the second connecting point 75c via the penetration conductor 53c. That is, a balanced type electrical signal inputted from an outside circuit is provided to the second input coupled electrode 40c via the second auxiliary input coupling electrode 42c.

Therefore, the coupling (second additional coupling) between the second auxiliary input coupling electrode 42c and the first auxiliary input resonance electrodes 31a is added to the coupling between the second input coupling electrode 40c and the left half portion 302a of the input resonance electrodes 30a, thereby making the overall coupling an inter-digital coupling. Therefore the overall coupling is strong.

Consequently, the coupling mentioned above can have a stronger coupling than that without the second additional coupling or that in a case in which the second auxiliary input coupling electrode 42c is connected to the second input terminal electrode 60c the second coupling contact point 74c instead of the second connecting point 75c.

The first auxiliary output coupling electrode 42b comprises a third coupling contact point 74b and a third connecting point 75b. The third coupling contact point 74b is connected to the first output contact point 71b via a penetration conductor 52b, and the third connecting point 75a is connected to the third input terminal 60b via a penetration conductor 53b. A part of the first auxiliary output coupling electrode 42b is configured to face the first auxiliary output resonance electrode 31c.

The first auxiliary output coupling electrode 42b connected to the first output coupling electrode 40b and the first auxiliary output resonance electrodes 31b connected to the right half portion 301b of the output resonance electrode 30b are broad-side coupled. In addition, a part of the first auxiliary output coupling electrode 42b faces the first auxiliary output resonance electrode 31a and is connected to the first output terminal electrode 60b at the third connecting point 75b via the penetration conductor 53b. That is, a balanced type electrical signal is outputting to an outside circuit from the first output coupled electrode 40b via the first auxiliary output coupling electrode 42b.

Therefore, the coupling (third additional coupling) between the first auxiliary output coupling electrode 42b and the first auxiliary output resonance electrodes 31b is added to the coupling between the first output coupling electrode 40b and the right half portion 301b of the output resonance electrodes 30b, thereby making the overall coupling an inter-digital coupling. Therefore the overall coupling is strong.

Consequently, the coupling mentioned above can have a stronger coupling than that without the first additional coupling or that in a case in which the first auxiliary output coupling electrode 42b is connected to the first output terminal electrode 60b at the third coupling contact point 74a instead of the third connecting point 75a.

The second auxiliary output coupling electrode 42d comprises a fourth coupling contact point 74d and a fourth connecting point 75a. The fourth coupling contact point 74d is connected to the second output contact point 71d via a penetration conductor 52d, and the fourth connecting point 75d is connected to the second output terminal 60d via a penetration conductor 53d. A part of the second auxiliary output coupling electrode 42d is configured to face the first auxiliary output resonance electrode 31d.

The second auxiliary output coupling electrode 42d connected to the second output coupling electrode 40d and the second auxiliary output resonance electrodes 31d connected to the left half portion 302b of the output resonance electrode 30b are broad-side coupled. In addition, a part of the second auxiliary output coupling electrode 42b faces the second auxiliary output resonance electrode 31a and is connected to the second output terminal electrode 60d at the fourth connecting point 75b via the penetration conductor 53d. That is, a balanced type electrical signal is outputting to an outside circuit from the second output coupled electrode 40d via the second auxiliary output coupling electrode 42b.

Therefore, the coupling (fourth additional coupling) between the second auxiliary output coupling electrode 42d and the second auxiliary output resonance electrodes 31d is added to the coupling between the second output coupling electrode 40d and the left half portion 302b of the output resonance electrodes 30b, thereby making the overall coupling an inter-digital coupling. Therefore the overall coupling is strong.

Consequently, the coupling mentioned above can have a stronger coupling than that without the fourth additional coupling or that in a case in which the second auxiliary output coupling electrode 42d is connected to the second output terminal electrode 60d at the fourth coupling contact point 74d instead of the fourth connecting point 75d.

The bandpass filter 500 with such a structure can reduce an increase of insertion loss at frequencies between resonance frequencies of resonance mode even in the broad pass band, and has a flat and low-loss transmission characteristic over the entire region of the broad pass band.

In an embodiment, the widths of the auxiliary input coupling electrode 42a, 42c and auxiliary output coupling electrodes 42b, 42d may be set, without limitation, to be substantially the same as those of the input coupling electrodes 40a, 40c and the output coupling electrodes 40b, 40d, respectively. The lengths of the auxiliary input coupling electrode 42a, 42c and auxiliary output coupling electrodes 42b, 42d may be set, without limitation, to be substantially the same as those of the input auxiliary resonance electrodes 31a, 31c and the output auxiliary resonance electrodes 31b, 31d, respectively. As the dielectric layer 103 which is equal to the distance between the auxiliary coupling electrodes 42a, 42b, 42c, 42d and the auxiliary resonance electrodes 31a, 31b, 30c, 31d is thinner, each coupling may become stronger but they may become difficult to be manufactured. Therefore, the thickness of the dielectric layer 103 (i.e. the distance between the auxiliary coupling electrodes and the auxiliary resonance electrodes) is set, without limitation, to about 0.01 to 0.5 mm.

According to an embodiment of the present invention, one or more additional auxiliary resonance electrodes (not shown) may be added to the auxiliary resonance electrodes 31a, 31b, 30c and 31d in another dielectric layer. For example, the additional auxiliary resonance electrodes may be located on a dielectric layer (not shown) which is under the dielectric layer 101 on which the resonance electrodes 30a, 30b, 30c and 30d are located.

In addition, the additional auxiliary resonance electrodes may be electrically connected to the first central resonance electrode 30c or the second central resonance electrode 30d via penetration conductors. This configuration can make the capacitance bigger if the size of the resonance electrodes 30a, 30b, 30c and 30d is same, and make the size of the resonance electrodes 30a, 30b, 30c and 30d smaller if the capacitance is same.

Furthermore, the bandpass filter 500 may comprise one or more additional couplings added to the couplings between the coupling electrodes 40a, 40b, 40c and 40d and the resonance electrodes 30a and 30b, and between the auxiliary input coupling electrodes 42a, 42b, 42c and 42d and the auxiliary input resonance electrode 31a, 31b, 31c and 31d. The additional electrode for additional couplings may be located in any inter-layer(s).

In the same manner, the bandpass filter 500 may comprise another pair of electrode for output and the additional coupling can be added to the coupling between the first output coupling electrode 40b and the output resonance electrode 30b, and between the first auxiliary output coupling electrode 42b and the first auxiliary output resonance electrode 31b (or between the second output coupling electrode 40d and the output resonance electrode 30b, and between the second auxiliary output coupling electrode 42d and the second auxiliary output resonance electrode 31d).

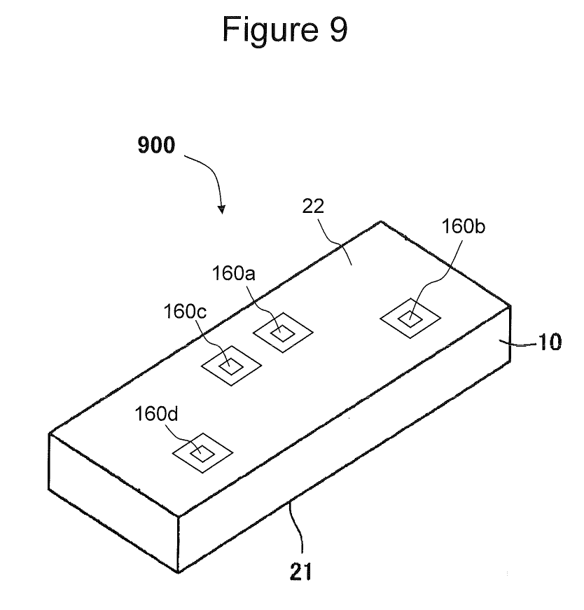

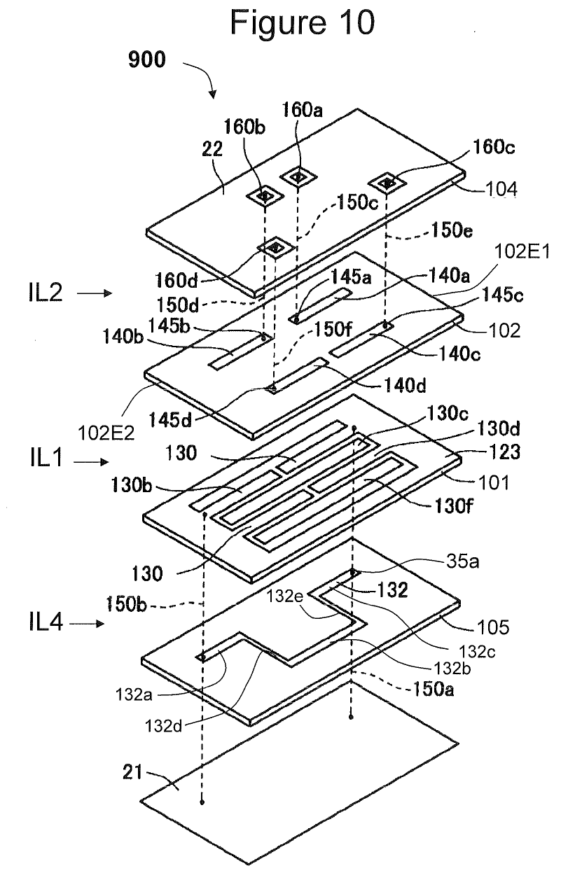

FIG. 9 is a perspective view schematically illustrating the external appearance of a bandpass filter 900 according to one embodiment of the present invention. FIG. 10 is an exploded perspective view schematically illustrating the bandpass filter 900 shown in FIG. 9.

The following descriptions focus on only the differences from the embodiments shown in FIGS. 1 to 4, wherein the same reference numerals refer to the same constitutional elements, and therefore, the repetitive descriptions will be omitted.

The following description focuses on only the differences from the embodiments shown in FIGS. 1 to 4, wherein the same reference numerals refer to the same constitutional elements, and therefore, the repetitive descriptions will be omitted.

A bandpass filter 900 shown in FIG. 10 comprises a laminated body 10. The laminate 10 comprises dielectric layers of which dielectric layers 101, 102, 104 and 105 are shown in FIG. 10. The bandpass filter 900 further comprises a first ground electrode 21, a second ground electrode 22. In FIG. 10, the first ground electrode 21 is illustrated as a layer but it is located on the bottom surface of the dielectric layer 105. The second ground electrode 22 is located on an upper surface of the dielectric layer 104.

The bandpass filter 900 further comprises an input/output-stage ½ wavelength resonant electrode 130f, a central-stage ½ wavelength resonant electrode 130c, a first central-stage ¼ wavelength resonant electrode 130d, a second central-stage ¼ wavelength resonant electrode 130e, a first input/output-stage ¼ wavelength resonant electrode 130a, a second input/output-stage ¼ wavelength resonant electrode 130b. The input/output-stage ½ wavelength resonant electrode 130f, the central-stage ½ wavelength resonant electrode 130c, the first central-stage ¼ wavelength resonant electrode 130d, the second central-stage ¼ wavelength resonant electrode 130e, the first input/output-stage ¼ wavelength resonant electrode 130a and the second input/output-stage ¼ wavelength resonant electrode 130b are located on the dielectric layer 101.

The bandpass filter 900 further comprises a first coupling electrode 140a, a second coupling electrode 140b, a third coupling electrode 140c, a fourth coupling electrode 140d, and a resonant electrode coupling conductor 132. The first coupling electrode 140a, the second coupling electrode 140b, the third coupling electrode 140c and the fourth coupling electrode 140d are located on the dielectric layer 102. The resonant electrode coupling conductor 132 is located on the dielectric layer 105.

The input/output-stage ½ wavelength resonant electrode 130f and the central-stage ½ wavelength resonant electrode 130c are disposed in a first inter-layer IL1 of the laminate in parallel with each other. The first central-stage ¼ wavelength resonant electrode 130d is disposed in the first inter-layer IL1 between the input/output-stage ½ wavelength resonant electrode 130f and the central-stage ½ wavelength resonant electrode 130c such that electromagnetic field coupling is mutually generated between the first central-stage ¼ wavelength resonant electrode 130d and the input/output-stage ½ wavelength resonant electrode 130f and central-stage ½ wavelength resonant electrode 130c. The first central-stage ¼ wavelength resonant electrode 130d faces a one-end-side region on one end side from a center in a length direction of the input/output-stage ½ wavelength resonant electrode 130f, and the first central-stage ¼ wavelength resonant electrode 130d also faces a one-end-side region on one end side from the center in the length direction of the central-stage ½ wavelength resonant electrode 130c. In the first central-stage ¼ wavelength resonant electrode 130d, an end portion close to one end of each of the input/output-stage ½ wavelength resonant electrode 130f and the central-stage ½ wavelength resonant electrode 130c forms a ground end, and the opposite end portion forms an open end. The second central-stage ¼ wavelength resonant electrode 130e is disposed in the first inter-layer IL1 between the input/output-stage ½ wavelength resonant electrode 130f and the central-stage ½ wavelength resonant electrode 130c such that the electromagnetic field coupling is mutually generated between the second central-stage ¼ wavelength resonant electrode 130e and the input/output-stage ½ wavelength resonant electrode 130f and central-stage ½ wavelength resonant electrode 130c. The second central-stage ¼ wavelength resonant electrode 130e faces the-other-end-side region on the other end side from the center in the length direction of the input/output-stage ½ wavelength resonant electrode 130f, and the second central-stage ¼ wavelength resonant electrode 130e also faces the-other-end-side region on the other end side from the center in the length direction of the central-stage ½ wavelength resonant electrode 130c. In the second central-stage ¼ wavelength resonant electrode 130e, an end portion close to the other end of each of the input/output-stage ½ wavelength resonant electrode 130f and the central-stage ½ wavelength resonant electrode 130c forms the ground end, and the opposite end portion forms the open end.

The first input/output-stage ¼ wavelength resonant electrode 130a is disposed such that the electromagnetic field coupling is mutually generated between the first input/output-stage ¼ wavelength resonant electrode 130a and the central-stage ½ wavelength resonant electrode 130c. The first input/output-stage ¼ wavelength resonant electrode 130a is located across the central-stage ½ wavelength resonant electrode 130c in the first inter-layer IL1 from the first central-stage ¼ wavelength resonant electrode 130d, and the first input/output-stage ¼ wavelength resonant electrode 130a faces the one-end-side region of the central-stage ½ wavelength resonant electrode 130c. In the first input/output-stage ¼ wavelength resonant electrode 130a, an end portion close to one end of the central-stage ½ wavelength resonant electrode 130c forms the ground end, and the opposite end portion forms the open end. The second input/output-stage ¼ wavelength resonant electrode 130b is disposed such that the electromagnetic field coupling is mutually generated between the second input/output-stage ¼ wavelength resonant electrode 130b and the central-stage ½ wavelength resonant electrode 130c. The second input/output-stage ¼ wavelength resonant electrode 130b is located across the central-stage ½ wavelength resonant electrode 130c in the first inter-layer IL1 from the second central-stage ¼ wavelength resonant electrode 130e, and the second input/output-stage ¼ wavelength resonant electrode 130b faces the-other-end-side region of the central-stage ½ wavelength resonant electrode 130c. In second input/output-stage ¼ wavelength resonant electrode 130b, an end portion close to the other end of the central-stage ½ wavelength resonant electrode 130c forms the ground end, and the opposite end portion forms the open end.

The first coupling electrode 140a is disposed in a second inter-layer IL2 such that the electromagnetic field coupling is generated between the first coupling electrode 140a and the first input/output-stage ¼ wavelength resonant electrode 130a. The second inter-layer IL2 is different from the first inter-layer IL1 of the laminate. The first coupling electrode 140a faces the first input/output-stage ¼ wavelength resonant electrode 130a. The second coupling electrode 140b is disposed in the second inter-layer IL2 such that the electromagnetic field coupling is generated between the second coupling electrode 140b and the second input/output-stage ¼ wavelength resonant electrode 130b. The second coupling electrode 140b faces the second input/output-stage ¼ wavelength resonant electrode 130b. The third coupling electrode 140c is disposed in the second inter-layer IL2 such that the electromagnetic field coupling is generated between the third coupling electrode 140c and the input/output-stage ½ wavelength resonant electrode 130f. The third coupling electrode 140c faces the one-end-side region of the input/output-stage ½ wavelength resonant electrode 130f. The fourth coupling electrode 140d is disposed in the second inter-layer IL2 such that the electromagnetic field coupling is generated between the fourth coupling electrode 140d and the input/output-stage ½ wavelength resonant electrode 130f. The fourth coupling electrode 140d faces the-other-end-side region of the input/output-stage ½ wavelength resonant electrode 130f.

The resonant electrode coupling conductor 132 is disposed in a third inter-layer IL3 that is located across the first inter-layer IL1 of the laminate from the second inter-layer IL2. The resonant electrode coupling conductor 132 comprises a first portion 132a, a second portion 132b, a third portion 132c and connecting portions 132d and 132e.

In the resonant electrode coupling conductor 132, one end is grounded near the ground terminal of the first input/output-stage ¼ wavelength resonant electrode 130a. The resonant electrode coupling conductor 132 has a region that faces the ground end side of the first input/output-stage ¼ wavelength resonant electrode 130a such that the electromagnetic field coupling is generated between the resonant electrode coupling conductor 132 and the first input/output-stage ¼ wavelength resonant electrode 130a. In the resonant electrode coupling conductor 132, the other end is grounded near the ground terminal of the second input/output-stage ¼ wavelength resonant electrode 130b. The resonant electrode coupling conductor 132 has a region that faces the ground end side of the second input/output-stage ¼ wavelength resonant electrode 130b such that the electromagnetic field coupling is generated between the resonant electrode coupling conductor 132 and the second input/output-stage ¼ wavelength resonant electrode 130b. In a central portion, the resonant electrode coupling conductor 132 has a region that faces both the other end side from the center of the one-end-side region of the input/output-stage ½ wavelength resonant electrode 130f and one end side from the center of the-other-end-side region of the input/output-stage ½ wavelength resonant electrode 130f.

An annular ground electrode 123 is formed in the first inter-layer IL3 of the laminate so as to surround the input/output-stage ½ wavelength resonant electrode 130f, the central-stage ½ wavelength resonant electrode 130c, the first central-stage ¼ wavelength resonant electrode 130d, the second central-stage ¼ wavelength resonant electrode 130e, the first input/output-stage ¼ wavelength resonant electrode 130a, and the second input/output-stage ¼ wavelength resonant electrode 130b. The annular ground electrode 123 is connected to ground terminals of the first central-stage ¼ wavelength resonant electrode 130d, second central-stage ¼ wavelength resonant electrode 130e, first input/output-stage ¼ wavelength resonant electrode 130a, and second input/output-stage ¼ wavelength resonant electrode 130b. One end of the resonant electrode coupling conductor 132 is connected to the first ground electrode 21 and annular ground electrode 123 through a penetration conductor 150a near the ground terminal of the first input/output-stage ¼ wavelength resonant electrode 130a, and the other end is connected to the first ground electrode 21 and annular ground electrode 123 through a penetration conductor 150b near the ground terminal of the second input/output-stage ¼ wavelength resonant electrode 130b.

In the first coupling electrode 140a, a first input/output point 145a is located so as to face the open end side from the center of the first input/output-stage ¼ wavelength resonant electrode 130a. The first input/output point 145a is connected to a penetration conductor 150c, and one of differential signals is fed into or supplied from the first input/output point 145a. In the second coupling electrode 140b, a second input/output point 145b is located so as to face the open end side from the center of the second input/output-stage ¼ wavelength resonant electrode 130b. The second input/output point 145b is connected to a penetration conductor 150d, and the other of the differential signals is fed into or supplied from the second input/output point 145b. In the third coupling electrode 140c, a third input/output point 145c is located so as to face one end side from the center of the one-end-side region of the input/output-stage ½ wavelength resonant electrode 130f. The third coupling electrode 140c is connected to a penetration conductor 150e, and one of differential signals is fed into or supplied from the third coupling electrode 140c. In the fourth coupling electrode 140d, a fourth input/output point 145d is located so as to face the other end side from the center of the-other-end-side region of the input/output-stage ½ wavelength resonant electrode 130f. The fourth input/output point 145d is connected to a penetration conductor 150f, and the other of the differential signals is fed into or supplied from the fourth input/output point 145d.

The electromagnetic field coupling is generated between the first input/output-stage ¼ wavelength resonant electrode 130a and second input/output-stage ¼ wavelength resonant electrode 130b and the central-stage ½ wavelength resonant electrode 130c in an interdigital manner, the electromagnetic field coupling is generated between the central-stage ½ wavelength resonant electrode 130c and the first central-stage ¼ wavelength resonant electrode 130d and second central-stage ¼ wavelength resonant electrode 130e in the interdigital manner, and the electromagnetic field coupling is generated between the first central-stage ¼ wavelength resonant electrode 130d and second central-stage ¼ wavelength resonant electrode 130e and the input/output-stage ½ wavelength resonant electrode 130f in the interdigital manner. Accordingly, the electromagnetic field coupling is generated in all the adjacent resonant electrodes in the interdigital manner. The coupling by the electric field and the coupling by the magnetic field are added to generate the coupling stronger than that of comb-line type coupling. Therefore, a frequency interval between resonant frequencies in each resonant mode can properly be set to obtain a largely wide passband width having a fractional bandwidth of about 40%. The passband width having the fractional bandwidth of about 40% far exceeds the region that can be realized with the filter in which the conventional ¼ wavelength resonator is used.

The first coupling electrode 140a and second coupling electrode 140b and the first input/output-stage ¼ wavelength resonant electrode 130a and second input/output-stage ¼ wavelength resonant electrode 130b are broad-side coupled and coupled in the interdigital manner. The third coupling electrode 140c and fourth coupling electrode 140d and the one-end-side region and the-other-end-side region of the input/output-stage ½ wavelength resonant electrode 130f are broad-side coupled and coupled in the interdigital manner. The broad-side coupling is stronger than the edge coupling. Further, because the coupling is performed in the interdigital manner, as with the above-described coupling between the resonant electrodes, the coupling by the magnetic field and the coupling by the electric field are added to generate the strong coupling. Therefore, the significantly strong coupling is generated between the first coupling electrode 140a and second coupling electrode 140b and the first input/output-stage ¼ wavelength resonant electrode 130a, between the first coupling electrode 140a and second coupling electrode 140b and the second input/output-stage ¼ wavelength resonant electrode 130b, and between the third coupling electrode 140c and fourth coupling electrode 140d and the one-end-side region and the-other-end-side region of the input/output-stage ½ wavelength resonant electrode 130f, which allows the novel bandpass filter to be obtained. In the novel bandpass filter, even in the passband that far exceeds the region that can be realized with the filter in which the conventional ¼ wavelength resonator is used, the insertion loss is not largely increased in the frequency located between the resonant frequency in each resonant mode, the insertion loss becomes flat in the whole region of the passband, and the low-loss bandpass characteristic can be obtained.

Two filter circuits are connected in parallel. One of the filter circuits comprises the four-stage resonant electrode having the first input/output-stage ¼ wavelength resonant electrode 130a, the one-end-side region of the central-stage ½ wavelength resonant electrode 130c, and the one-end-side regions of the first central-stage ¼ wavelength resonant electrode 130d and input/output-stage ½ wavelength resonant electrode 130f. The other filter circuit comprises the four-stage resonant electrode having the second input/output-stage ¼ wavelength resonant electrode 130b, the-other-end-side region of the central-stage ½ wavelength resonant electrode 130c, and the-other-end-side regions of the second central-stage ¼ wavelength resonant electrode 130e and input/output-stage ½ wavelength resonant electrode 130f. In each filter circuit including the four-stage resonant electrode, inductive coupling is generated by the resonant electrode coupling conductor 132 between the first-stage resonant electrode and the last-stage resonant electrode. In each filter circuit, the adjacent resonant electrodes are coupled in the interdigital manner, and the coupling by the magnetic field and the coupling by the electric field are added to generate the strong coupling. However, in the filter circuit, capacitive coupling is generated as a whole. Therefore, a phase difference of 180° is generated between a signal that is transmitted by the inductive coupling between the first-stage resonant electrode and the last-stage resonant electrode of the filter circuit including the four-stage resonant electrode through the resonant electrode coupling conductor 132 and a signal that is transmitted by the capacitive coupling between the adjacent resonant electrodes, so that a phenomenon in which the signals are cancelled each other can be generated. Because the phenomenon can be generated near both sides of the passband of the bandpass filter, an attenuation pole in which the signal is hardly transmitted can be formed near both sides of the passband in the bandpass characteristic of the bandpass filter.

The annular ground electrode 123 is formed in the first inter-layer IL1 of the laminate so as to surround the input/output-stage ½ wavelength resonant electrode 130f, the central-stage ½ wavelength resonant electrode 130c, the first central-stage ¼ wavelength resonant electrode 130d, the second central-stage ¼ wavelength resonant electrode 130e, the first input/output-stage ¼ wavelength resonant electrode 130a, and the second input/output-stage ¼ wavelength resonant electrode 130b. Therefore, the ground terminals of the first input/output-stage ¼ wavelength resonant electrode 130a, second input/output-stage ¼ wavelength resonant electrode 130b, first central-stage ¼ wavelength resonant electrode 130d, and second central-stage ¼ wavelength resonant electrode 130e can easily be grounded by connecting the ground terminals to the annular ground electrode 123. By electromagnetically shielding the surround of each resonant electrode, an influence of an external electromagnetic noise can be reduced while a leakage of an electromagnetic wave generated from each resonant electrode to the surround can be reduced. The effect is particularly useful to prevent the adverse effect to other regions of the module board when the bandpass filter is formed in part of the region of the module board.

Even though an example has been described in the embodiments where the input/output terminal electrode 160a, 160b, 160c and 160d are provided, the input/output terminal electrodes 160a, 160b, 160c and 160d are not necessary in a case where the bandpass filter is formed on a region of the module substrate.

For example, an input wiring electrode from an external circuit in the module substrate and an output wiring electrode to the external circuit in the module substrate may be directly connected to one of the coupling electrodes 140a, 140b, 140c and 140d. In this case, contact points of the coupling electrode 140a, 140b, 140c and an electrical signal inputted from or outputted to the external circuit is supplied to the input/output coupling electrodes 145a, 145b, 145C and 145d.

In addition, the bandpass filter 900 shown in FIGS. 9 and 10 comprises one resonance coupling conductor 132. However, the number of the resonance coupling conductors is not limited to one. A bandpass filter may comprise two or more resonance coupling conductors.

In one embodiment, a bandpass filter may have two or more resonance coupling electrodes.

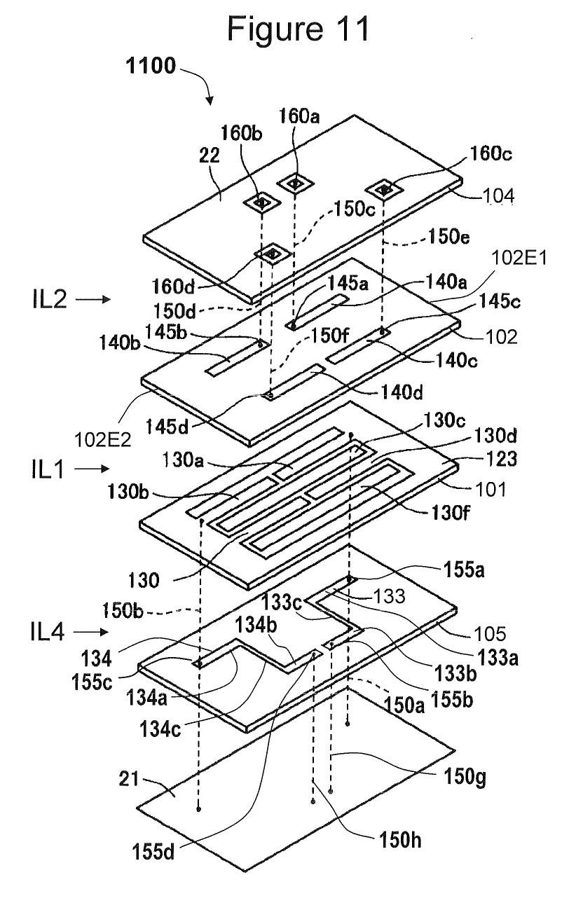

FIG. 11 is an exploded perspective view schematically illustrating a bandpass filter 1100 according to one embodiment of the present invention. Referring to FIG. 11, the bandpass filter 1100 comprises two resonance coupling electrodes, a first resonance coupling electrode 133 and a second resonance coupling electrode 134. The resonant electrode coupling conductors 133 and 134 are disposed on the dielectric layer 105.

The first resonance coupling electrode 133 comprises a first portion 133a, a second portion 133b and a third portion 133c. The third portion 133c electrically connects the first portion 133a with the second portion 133b. The first portion 133a comprises a first end. The first portion 133a also comprises a first connection point 155a near the first end. The second portion 133b comprises a second end. The second portion 133b also comprises a second connection point 155b near the second end.

The second resonance coupling electrode 134 comprises a fourth portion 134a, a fifth portion 134b and a sixth portion 134c. The fourth portion 134a comprises a third end. The fourth portion 133a also comprises a third connection point 155c near the third end. The fifth portion 134b comprises a fourth end. The fifth portion 134b also comprises a fourth connection point 155d near the fourth end. The third portion 134c electrically connects the first portion 134a with the second portion 134b.

The first connection point 155a and the third connection point 155c are electrically connected to the first ground 21 via a penetration conductor 150a and 150c, respectively. The second connection point 155b and the fourth connection point 155d are electrically connected to the first ground 21 via a penetration conductor 150g and 150h, respectively.

The first part 133a faces the first input/output-stage ¼ wavelength resonant electrode 130a such that the electromagnetic field coupling is generated between the resonant electrode coupling conductor 133 and the input/output-stage ¼ wavelength resonant electrode 130a. The second portion 133b faces the second input/output-stage ¼ wavelength resonant electrode 130b such that the electromagnetic field coupling is generated between the resonant electrode coupling conductor 133 and the second input/output-stage ¼ wavelength resonant electrode 130b.

The first part 134a faces one-end-side region of the input/output-stage ½ wavelength resonant electrode 130f such that the electromagnetic field coupling is generated between the resonant electrode coupling conductor 134 and the input/output-stage ½ wavelength resonant electrode 130f. The second portion 134b faces the other-end-side region of the input/output-stage ½ wavelength resonant electrode 130f such that the electromagnetic field coupling is generated between the resonant electrode coupling conductor 133 and the input/output-stage ½ wavelength resonant electrode 130f.

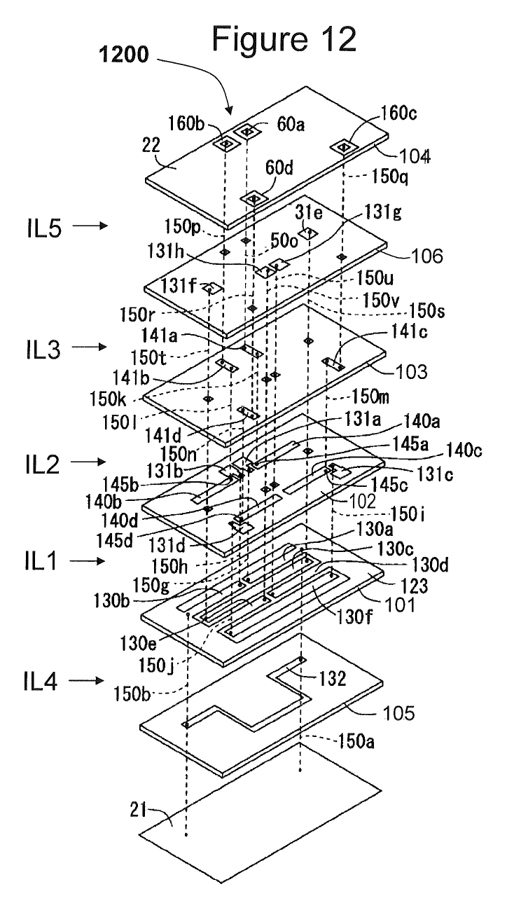

FIG. 12 is an exploded perspective view schematically illustrating a bandpass filter 1200 according to an embodiment of the present invention. The following descriptions focus on only the differences from the embodiment shown in FIG. 10, wherein the same reference numerals refer to the same constitutional elements, and therefore, the repetitive descriptions will be omitted.

In a bandpass filter 1200 of FIG. 12, a first auxiliary resonant electrode 131a that is connected to the open end side of the first input/output-stage ¼ wavelength resonant electrode 130a by a penetration conductor 150g, a second auxiliary resonant electrode 131b that is connected to the open end side of the second input/output-stage ¼ wavelength resonant electrode 130b by a penetration conductor 150h, a third auxiliary resonant electrode 131c that is connected to one end side in the one-end-side region of the input/output-stage ½ wavelength resonant electrode 130f by a penetration conductor 150i, and a fourth auxiliary resonant electrode 131d that is connected to the other end side in the-other-end-side region of the input/output-stage ½ wavelength resonant electrode 130f by a penetration conductor 150j are disposed in the second inter-layer IL2 of the laminate. The first auxiliary resonant electrode 131a, the second auxiliary resonant electrode 131b, the third auxiliary resonant electrode 131c, and the fourth auxiliary resonant electrode 131d are disposed so as to have the regions facing the annular ground electrode 123, respectively.

The bandpass filter 1200 of FIG. 12 comprises a first auxiliary coupling electrode 141a, a second auxiliary coupling electrode 141b, a third auxiliary coupling electrode 141c, and a fourth auxiliary coupling electrode 141d in a third inter-layer IL3 that is located across the second inter-layer IL2 from the first inter-layer IL1. The first auxiliary coupling electrode 141a is connected to the first input/output point 145a of the first coupling electrode 140a by a penetration conductor 150k, and is disposed so as to have a region facing the first auxiliary resonant electrode 131a. The second auxiliary coupling electrode 141b is connected to the second input/output point 145b of the second coupling electrode 140b by a penetration conductor 150l, and is disposed so as to have a region facing the second auxiliary resonant electrode 131b. The third auxiliary coupling electrode 141c is connected to the third input/output point 145c of the third coupling electrode 140c by a penetration conductor 150m, and is disposed so as to have a region facing the third auxiliary resonant electrode 131c. The fourth auxiliary coupling electrode 141d is connected to the fourth input/output point 145d of the fourth coupling electrode 140d by a penetration conductor 150n, and is disposed so as to have a region facing the fourth auxiliary resonant electrode 131d.

A first input/output terminal electrode 160a and a second input/output terminal electrode 160b are connected to the first auxiliary coupling electrode 141a and the second auxiliary coupling electrode 141b through penetration conductors 150o and 150p, respectively. A third input/output terminal electrode 160c and a fourth input/output terminal electrode 160d are connected to the third auxiliary coupling electrode 141c and the fourth auxiliary coupling electrode 141d through penetration conductors 150q and 150r, respectively. The differential signals are fed and supplied between the first coupling electrode 140a and second coupling electrode 140b and an external circuit through the first input/output terminal electrode 160a and second input/output terminal electrode 160b, the first auxiliary coupling electrode 141a and second auxiliary coupling electrode 141b, and the penetration conductors 150o and 150p. The differential signals are fed and supplied between the third coupling electrode 140c and fourth coupling electrode 140d and the external circuit through the third input/output terminal electrode 160c and fourth input/output terminal electrode 160d, and the third auxiliary coupling electrode 141c and fourth auxiliary coupling electrode 141d, and the penetration conductors 150q and 150r, thereby acting as a bandpass filter in which the differential input/output can be performed.

The bandpass filter 1200 of FIG. 12 further comprises an auxiliary resonant electrode 131e, an auxiliary resonant electrode 131f, an auxiliary resonant electrode 131g, and an auxiliary resonant electrode 131h in a fifth inter-layer IL25 located between the first inter-layer IL1 of the laminate and the upper surface of the laminate so as to face the second ground electrode 22. The auxiliary resonant electrode 131e and the auxiliary resonant electrode 131f are connected to one end side and the other end side of the central-stage ½ wavelength resonant electrode 130c by penetration conductors 150s and 150t, respectively. The auxiliary resonant electrode 131g and the auxiliary resonant electrode 131h are connected to the open end sides of the first central-stage ¼ wavelength resonant electrode 130d and second central-stage ¼ wavelength resonant electrode 130e by penetration conductors 150u and 150v, respectively.

The coupling by the electromagnetic field between the first auxiliary coupling electrode 141a and second auxiliary coupling electrode 141b and the first auxiliary resonant electrode 131a and second auxiliary resonant electrode 131b is added to the coupling by the electromagnetic field between the first coupling electrode 140a and second coupling electrode 140b and the first input/output-stage ¼ wavelength resonant electrode 130a and second input/output-stage ¼ wavelength resonant electrode 130b.

The coupling by the electromagnetic field between the third auxiliary coupling electrode 141c and fourth auxiliary coupling electrode 141d and the third auxiliary resonant electrode 131c and fourth auxiliary resonant electrode 131d is added to the coupling by the electromagnetic field between the third coupling electrode 140c and fourth coupling electrode 140d and the one-end-side region and the-other-end-side region of the input/output-stage ½ wavelength resonant electrode 130f.

Therefore, the coupling by the electromagnetic field between the first coupling electrode 140a and second coupling electrode 140b and the first input/output-stage ¼ wavelength resonant electrode 130a and a second input/output-stage ¼ wavelength resonant electrode 130b and the coupling by the electromagnetic field between the third coupling electrode 140c and fourth coupling electrode 140d and the one-end-side region and the-other-end-side region of the input/output-stage ½ wavelength resonant electrode 130f are further strengthened.

The first auxiliary resonant electrode 131a, the second auxiliary resonant electrode 131b, the third auxiliary resonant electrode 131c, and the fourth auxiliary resonant electrode 131d are disposed so as to have the regions facing the annular ground electrode 123, respectively. The auxiliary resonant electrode 131e, the auxiliary resonant electrode 131f, the auxiliary resonant electrode 131g, and the auxiliary resonant electrode 131h are disposed so as to have the regions facing the second ground electrode 22. A length of the resonant electrode connected to each auxiliary resonant electrode is shortened by an electrostatic capacitance generated between each auxiliary resonant electrode and the annular ground electrode 23 or second ground electrode 22, so that the compact bandpass filter can be obtained.

A wireless communication module and a radio communication device according to one embodiment of the invention may use any one of the bandpass filters mentioned in the above embodiments.

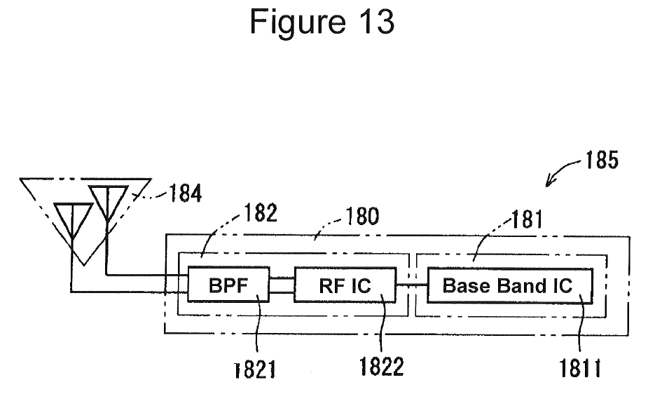

FIG. 13 is a block diagram illustrating a constructional example of a wireless communication module 180 and a radio communication device 185 using the wireless communication module 180 according to an embodiment of the present invention, which utilizes a bandpass filter according to the embodiments of the present invention.

The wireless communication module 180 comprises a base band module 181 that performs a processing of a base band signal, and a RF module connected to the base band module 181 and configured to perform a RF signal processing before modulating the base band signal and after reconstructing the signal.

The RF module 182 comprises the bandpass filter 1821. The bandpass filter 1821 can reduce RF signals modulated of the base band signal or received RF signals at a frequency range other than the pass band.

Specifically, the base band module comprises a base band IC 1811, and RF module 182 comprises a RF IC 1822 between the pass filter 1821 and base band module 181. It is not needless to say that the wireless communication can comprise another circuit between these modules.

The wireless communication device 85 further comprises an antenna 184 connected to the bandpass filter 1821 of the high frequency module 180. When passing through the bandpass filter 1821, a transmission signal outputted from the wireless communication device 185 is transmitted through the antenna 84. When passing through the bandpass filter 1821, a receipt signal received through the antenna 84 enters into the wireless communication device 185, with the signals having frequencies other than the communication band attenuated.

In the bandpass filters according to the embodiments of the present invention, the dielectric layers 111 may comprise a resin such as epoxy resin, or ceramics such as dielectric ceramics. For example, a glass-ceramic material may be appropriately used which comprises a dielectric ceramic material such as BaTiO₃, Pb₄Fe₂Nb₂O₁₂, TiO₂ and a glass material such as B₂O₃, SiO₂, Al₂O₃, ZnO and may be sinterable at a relatively low temperature of about 800° C. to 1200° C. Further, the thickness of the dielectric layers 111 is set, for example, to about 0.05 to 0.4 mm.

A conductive material whose principle constituent is an Ag alloy of, for example, Ag, Ag—Pd, and Ag—Pt or Cu-based, W-based, Mo-based, and Pd-based conductive material is fairly appropriately used for the above-described various electrodes and penetration conductors. The thickness of the various electrodes is set, for example, on the order of 0.001 to 0.03 mm.

The bandpass filters according to the above embodiments may be manufactured, for example, as follows. To begin with, a proper organic solvent is added to ceramic based powder and mixed to form a slurry and then form a ceramic green sheet by a doctor blade method. Next, through-holes for penetration conductors, are formed at the obtained ceramic green sheet using a punching machine, and conductive paste such as Ag, Ag—Pd, Au, and Cu, is filled in the through-holes to form penetration conductors. Thereafter, the above described various electrodes are formed on the ceramic green sheet by lithography. Then, these are stacked and pressurized by a hot press device, and fired at a high temperature of 800° C. to 1050° C.

### Example 1

Electrical properties of the bandpass filter comprising a structure as shown in FIGS. 5 to 8 were calculated by simulation using a finite element method. The following conditions were used for calculation: relative dielectric constant of the dielectric layers is 9.4; dissipation factor of the dielectric layers is 0.0005; and conductivity of various electrodes is 3.0*10⁷ S/m.

In the above embodiments, the auxiliary resonance electrodes 131a, 131b, 131c, and 131d face the annular ground electrode 123. Alternatively, the auxiliary resonance electrodes 131a, 131b, 131c, and 131d may face the first ground electrode 21 or the second ground electrode 22.

In the above embodiments, the first ground electrode 21 is located on the bottom surface of the laminate. Alternatively, a dielectric layer may be located below the first ground electrode 21. In the same manner, a dielectric layer may be located on the second ground electrode 22.

As the shape measurements, the input and output resonance electrodes 30a, 30b were adapted to have the width of 0.4 mm, the length of 5.8 mm, the central resonance electrodes 30c, 30d were adapted to have the width of 0.4 mm, the length of 2.9 mm, and the interval of 0.13 mm between two adjacent resonance electrodes.

The input coupling electrodes 40a, 40c and the output coupling electrodes 40b, 40d were adapted to have the width of 0.3 mm and the length of 2.5 mm, and the auxiliary input coupling electrodes 41a, 41c and the auxiliary output coupling electrodes 41b, 41d were adapted to have the width of 0.3 mm and the length of 1.45 mm.

Each of the auxiliary resonance electrodes 31a, 31b, 31c and 31d was adapted to have a first rectangular portion and a second rectangular portion joined to each other; the first rectangular portion is arranged 0.3 mm away from an end of each of the resonance electrodes 30a and 30b, respectively, and has the width of 0.45 mm and the length of 0.8 mm; and the second rectangular portion is located from the first rectangular portion toward each of the resonance electrodes 30a and 30b and has the width of 0.2 mm and the length of 0.4 mm.

The third ground electrode was adapted to have a rectangular shape which has the width of 0.4 mm and the length of 0.8 mm. Each of the input terminal electrode 60a and the output terminal electrode 60b were adapted to have a square portion whose one edge is 0.3 mm long and to be 0.2 mm away from the second ground electrode 22.

In the external appearance, each of the first ground electrode 21, the second ground electrode 22, and the annular ground electrode 23 was adapted to have the width of 3 mm and the length of 8 mm, and the opening portion of the annular ground electrode 23 was adapted to have the width of 2.4 mm and the length of 6 mm.

The bandpass filter was overall adapted to have the width of 3 mm, the length of 8 mm, and the thickness of 0.91 mm, and to have the dielectric layer 101, on which resonance electrodes 30a, 30b, 30c and 30d are located, at the center thereof in the thickness direction. The thickness of the dielectric layer was adapted to be 0.065 mm. The thickness of various electrodes was adapted to be 0.01 mm, and the diameter of various penetration conductors was adapted to be 0.1 mm.

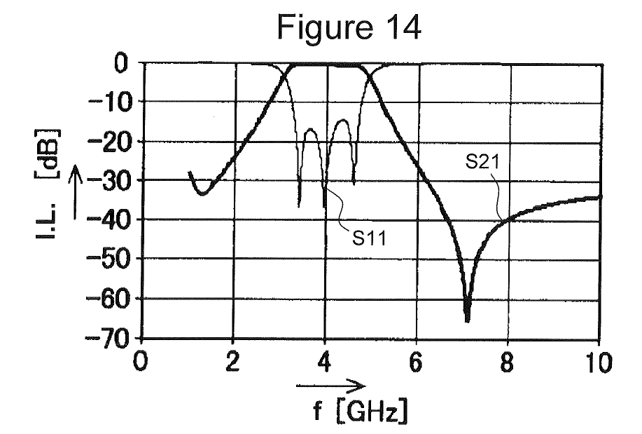

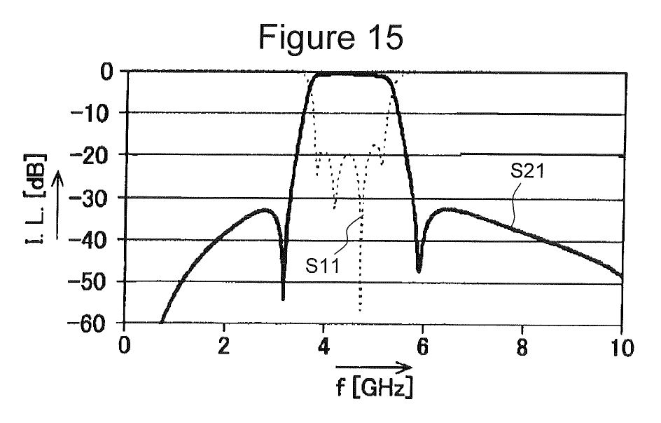

FIG. 14 is a graph illustrating a result of the simulation regarding an electrical characteristic of the bandpass filter, wherein horizontal axis refers to frequencies, vertical axis refers to losses, S21 refers to a transmission characteristic, and S11 refers to a reflection characteristic.

The graph illustrated in FIG. 14 shows the pass characteristics (S21) of the Loss of less than 1.5 dB occurs in the frequency range of 3.2 GHz to 4.7 GHz that corresponds to 40% by the relative bandwidth, which is even broader than the region realized by the conventional filter using the conventional ¼ wavelength resonator. As such, it could be possible to achieve an excellent transmission characteristic of being flat and of low loss over the entire region of the broad pass band and therefore the effectiveness of the present invention might be verified.

### Example 2

The transmission properties of the bandpass filter having the structure according to FIG. 12 were calculated by electromagnetic simulation. The following conditions were used for calculation: relative dielectric constant of the dielectric layer 11 is 9.4; dissipation factor is 0.0005; and conductivity is 3.0*10⁷ S/m.

As the shape measurements of the design values used for the trial production, the first and second input/output 1/4 resonance electrodes 130a, 130b and the first and second ¼ central resonance electrodes 130d, 130e were adapted to have the width of 0.4 mm, the length of 2.9 mm. The input/output ½ resonance electrode 130f and the ½ central resonance electrode 130c were adapted to have the width of 0.4 mm, the length of 5.8 mm, and each interval of neighboring resonance electrodes was 0.13 mm.

The first to fourth coupling electrodes 140a, 140b, 140c and 140d were adapted to have the width of 0.3 mm and the length of 2.5 mm, and the auxiliary coupling electrodes 141a, 141b, 141c and 141d were adapted to have the width of 0.3 mm and the length of 1.4 mm. Each of the first to fourth auxiliary resonance electrodes 131a, 131b, 131c, and 131d was adapted to have a first rectangular portion and a second rectangular portion joined to each other, wherein the first rectangular portion has the width of 0.55 mm, the length of 0.6 mm, and the second rectangular portion has the width of 0.2 mm and the length of 0.7 mm.

Each of the auxiliary resonance electrodes 131e, 131f, 131g and 131h was adapted to have a rectangular shape with the width of 0.65 mm and the length of 0.7 mm.

In the external appearance, each of the first ground electrode 21, the second ground electrode 22, and the annular ground electrode 123 was adapted to have the width of 4.6 mm and the length of 7.1 mm. The opening portion of the annular ground electrode 123 was adapted to have the width of 2.9 mm and the length of 6 mm.

Each of the input terminal electrode 60a and the output terminal electrode 60b was adapted to have a square portion whose one edge is 0.3 mm long and to be 0.2 mm away from the second ground electrode 22.

The bandpass filter was overall adapted to have the width of 4.6 mm, the length of 7.1 mm, and the thickness of 0.91 mm, and to have the upper surface of the dielectric layer 101 at the center thereof in the thickness direction. That is, the first inter-layer portion is at the center of the bandpass filter in the thickness direction.

The first portion 132a of the resonance electrode coupling conductor 132 has a rectangular shape with the width of 0.2 mm and the length of 1.7 mm. The second portion 132b of the resonance electrode coupling conductor 132 has a rectangular shape with the width of 0.2 mm and the length of 1.7 mm. The third portion 132c of the resonance electrode coupling conductor 132 has a rectangular shape with the width of 0.2 mm and the length of 3.2 mm. Each of the connection portions 132d and 132f of the resonance electrode coupling conductor 132 has a rectangular shape with the width of 0.1 mm.

The thickness of each of the dielectric layers 101, 102, 103, 104, 105 and 106 was adapted to be 0.065 mm. That is, the distance between neighboring inter-layer portions is 0.065 mm. The thickness of various electrodes was adapted to be 0.01 mm, and the diameter of various penetration conductors was adapted to be 0.1 mm.

FIG. 15 is a graph illustrating a result of the simulation regarding an electrical characteristic of the bandpass filter, wherein horizontal axis refers to frequencies, vertical axis refers to losses, S21 refers to a transmission characteristic, and S11 refers to a reflection characteristic.

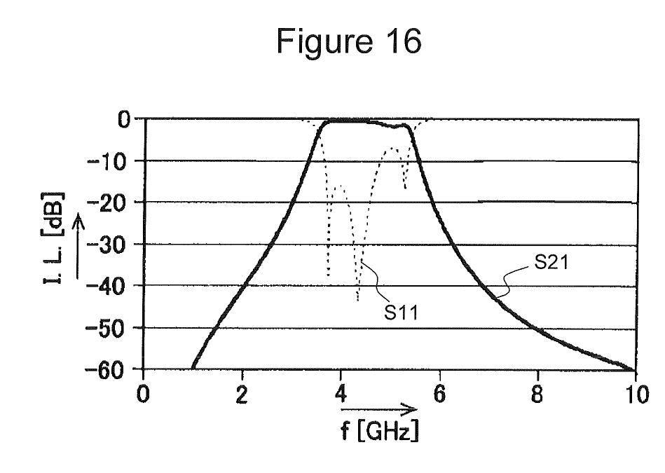

In the meanwhile, the transfer properties of the comparative bandpass filter having the configuration without the resonance electrode coupling conductor 132 shown in FIG. 12 were calculated by electromagnetic simulation. FIG. 16 shows a graph illustrating a result of the simulation regarding the transfer properties of the comparative bandpass filter wherein horizontal axis refers to frequencies, vertical axis refers to losses, S21 refers to a transmission characteristic, and S11 refers to a reflection characteristic.

The graph illustrated in FIG. 15 shows that the band pass filter has a loss in a wide frequency range that corresponds to 40% to 50% by the relative bandwidth than the existing filter having ¼ wavelength resonator.

In addition, compared to the transfer characteristics shown in the graph illustrated in FIG. 16, the bandpass filter has two attenuation poles obtained at the lower band side and at the higher band side than the pass band near the pass band, and has an abrupt attenuation characteristic near the both cutoff frequencies.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being included within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A bandpass filter, comprising:
a laminate comprising a plurality of dielectric layers;
a ground electrode on or in the laminate;
a first ½ wavelength resonance electrode and a second ½ wavelength resonance electrode in a first inter-layer portion of the laminate, in parallel with each other, and each having a strip shape and two open ends;
a first ¼ wavelength resonance electrode between the first ½ wavelength resonance electrode and the second ½ wavelength resonance electrode in the first inter-layer portion, having a strip shape, comprising a ground end and an open end, in parallel to a first half portion of the first ½ wavelength resonance electrode and a first half portion of the second ½ wavelength resonance electrode, and sandwiched by the first half portion of the first ½ wavelength resonance electrode and the first half portion of the second ½ wavelength resonance electrode;
a second ¼ wavelength resonance electrode between the first ½ wavelength resonance electrode and the second ½ wavelength resonance electrode in the first inter-layer portion, having a strip shape, comprising a ground end and an open end, in parallel to a second half portion of the first ½ wavelength resonance electrode and a second half portion of the second ½ wavelength resonance electrode, and sandwiched by the second half portion of the first ½ wavelength resonance electrode and the second half portion of the second ½ wavelength resonance electrode;
a first coupling electrode in a second inter-layer portion of the laminate, having a strip shape, facing the first half portion of the first ½ wavelength resonance electrode, and comprising a first connection point which faces a part of a half portion of the first half portion of the first ½ wavelength resonance electrode at the open end side;
a second coupling electrode in the second inter-layer portion, having a strip shape, facing the second half portion of the first ½ wavelength resonance electrode, and comprising a second connection point which faces a part of a half portion of the second half portion of the first ½ wavelength resonance electrode at the open end side;
a third coupling electrode in the second inter-layer portion, having a strip shape, facing the first half portion of the second ½ wavelength resonance electrode, and comprising a third connection point which faces a part of a half portion of the first half portion of the second ½ wavelength resonance electrode at the open end side;
a fourth coupling electrode in the second inter-layer portion, having a strip shape, facing the second half portion of the second ½ wavelength resonance electrode, and comprising a fourth connection point which faces a part of a half portion of the second half portion of the second ½ wavelength resonance at the open end side;

2. The bandpass filter according to claim 1,
wherein the first ¼ wavelength resonance electrode is operable to electromagnetically couple with the first half portion of the first ½ wavelength resonance electrode and the first half portion of the second ½ wavelength resonance electrode,
wherein the second ¼ wavelength resonance electrode is operable to electromagnetically couple with the second half portion of the first ½ wavelength resonance electrode and the second half portion of the second ½ wavelength resonance electrode,
wherein the first coupling electrode is operable to electromagnetically couple with the first half portion of the first ½ wavelength resonance electrode,
wherein the second coupling electrode is operable to electromagnetically couple with the second half portion of the first ½ wavelength resonance electrode;
wherein the third coupling electrode is operable to electromagnetically couple with the first half portion of the second ½ wavelength resonance electrode, and
wherein the fourth coupling electrode is operable to electromagnetically couple with the second half portion of the second ½ wavelength resonance electrode.

3. The bandpass filter according to claim 1, further comprising
an annular ground electrode on the first inter-layer portion, surrounding the first ½ wavelength resonance electrode, the second ½ wavelength resonance electrode, the first ¼ wavelength resonance electrode and the second ¼ wavelength resonance electrode, and connected to the ground end of the first ¼ wavelength resonance electrode and the ground end of the second ¼ wavelength resonance electrode.

4. The bandpass filter according to claim 3, further comprising:
a first auxiliary resonance electrode electrically connected to a first open end of the first ½ wavelength resonance electrode, and facing a part of the annular ground electrode; and
a second auxiliary resonance electrode electrically connected to a first open end of the second ½ wavelength resonance electrode, and facing a part of the annular ground electrode.
a second ground electrode facing the open end of the first ¼ wavelength resonance electrode.

5. The bandpass filter according to claim 4, further comprising:
a third auxiliary resonance electrode electrically connected to a second open end of the first ½ wavelength resonance electrode, and facing a part of the annular ground electrode; and
a fourth auxiliary resonance electrode electrically connected to a second open end of the second ½ wavelength resonance electrode, and facing a part of the annular ground electrode.
a second ground electrode facing the open end of the second ¼ wavelength resonance electrode.

6. The bandpass filter according to claim 5, further comprising:
a first auxiliary coupling electrode in a third inter-layer portion of the laminate, facing the first auxiliary resonance electrode, electrically connected to the first connecting point of the first coupling electrode;
a second auxiliary coupling electrode in the third inter-layer portion of the laminate, facing the third auxiliary resonance electrode, electrically connected to the second connecting point of the second coupling electrode;
a third auxiliary coupling electrode in the third inter-layer portion of the laminate, facing the second auxiliary resonance electrode, electrically connected to the third connecting point of the third coupling electrode; and
a fourth auxiliary coupling electrode in the third inter-layer portion of the laminate, facing the fourth auxiliary resonance electrode, electrically connected to the fourth connecting point of the fourth coupling electrode.

7. The bandpass filter according to claim 6, wherein
one of differential signals inputted from an exterior circuit is supplied to the first coupling electrode and the second coupling electrode via the first auxiliary coupling electrode and the second auxiliary coupling electrode, and
one of differential signals to be outputted to an exterior circuit is drawn from the third coupling electrode and the fourth coupling electrode via the third auxiliary coupling electrode and the fourth auxiliary coupling electrode.

8. A bandpass filter, comprising:
a laminate comprising a plurality of dielectric layers;
a ground electrode on or in the laminate;
a first ½ wavelength resonance electrode and a second ½ wavelength resonance electrode in a first inter-layer portion of the laminate, arranged in parallel with each other, and each having a strip shape and comprising a first half portion including a first open end and a second half portion including a second open end;
a first ½ wavelength resonance electrode located between the first ½ wavelength resonance electrode and the second ½ wavelength resonance electrode in the first inter-layer portion of the laminate, having a strip shape, facing and electromagnetically coupled to both the first half portion of the first ½ wavelength resonance electrode and the first half portion of the second ½ wavelength resonance electrode, and comprising a first ground end and an third open end, wherein the first ground end is closer to the first end of the first ½ wavelength resonance electrode and the first end of the second ½ wavelength resonance electrode than the third open end;
a second ¼ wavelength resonance electrode located between the first ½ wavelength resonance electrode and the second ½ wavelength resonance electrode in the first inter-layer portion of the laminate, having a strip shape, facing and electromagnetically coupled to both the second half portion of the first ½ wavelength resonance electrode and the second half portion of the second ½ wavelength resonance electrode, and comprising a second ground end and a fourth open end, wherein the second ground end is closer to the second end of the first ½ wavelength resonance electrode and the second end of the second ½ wavelength resonance electrode than the fourth open end;
a third ¼ wavelength resonance electrode in the first inter-layer portion of the laminate, located at the other side of the first ¼ wavelength resonance electrode with respect to the first ½ wavelength resonance electrode, having a strip shape, facing and electromagnetically coupled to the first half portion of the first ½ wavelength resonance electrode, and comprising a third ground end and a fifth open end, wherein the third ground end is closer to the first end of the first ½ wavelength resonance electrode than the fifth open end;
a fourth ¼ wavelength resonance electrode in the first inter-layer portion of the laminate, located at the other side of the second ¼ wavelength resonance electrode with respect to the first ½ wavelength resonance electrode, having a strip shape, facing and electromagnetically coupled to the second half portion of the first ½ wavelength resonance electrode, and comprising a fourth ground end and a sixth open end, wherein the fourth ground end is closer to the second end of the second ½ wavelength resonance electrode than the sixth open end;
a first coupling electrode in a second inter-layer portion of the laminate, having a strip shape, and facing the third ¼ wavelength resonance electrode, and comprising a first connection point which faces a part of a half portion of third ¼ wavelength resonance electrode at the open end side;
a second coupling electrode on the second inter-layer portion, having a strip shape, and facing the fourth ¼ wavelength resonance electrode, and comprising a second connection point which faces a part of a half portion of the fourth ¼ wavelength resonance electrode at the open end side;
a third coupling electrode on the second inter-layer portion, having a strip shape, and facing the first half portion of the second ½ wavelength resonance electrode, and comprising a third connection point which faces a part of a half portion of the first half portion of the second ½ wavelength resonance electrode at the open end side;
a fourth coupling electrode on the second inter-layer portion, having a strip shape, and facing the second half portion of the second ½ wavelength resonance electrode, and comprising a fourth connection point which faces a part of a half portion of the second half portion of the second ½ wavelength resonance electrode at the open end side; and
a resonant electrode coupling conductor in the third inter-layer portion of the laminate which is the opposite side of the second inter-layer portion with respect to the first inter-layer portion, having a strip shape, comprising:
a first coupling portion comprising a first end, which is connected to ground potential near the ground end of the third ¼ wavelength resonance electrode, and facing and electromagnetically coupled to at least a part of a half portion of the third ¼ wavelength resonance electrode at the ground end side;
a second coupling portion comprising a second end, which is connected to ground potential near the ground end of the fourth ¼ wavelength resonance electrode, and facing and electromagnetically coupled to at least a part of a half portion of the fourth ¼ wavelength resonance electrode at the ground end side; and
a third coupling portion facing and electromagnetically coupled to at least a center part of the first second ½ wavelength resonance electrode.

9. The bandpass filter according to claim 8, wherein
The resonant electrode coupling conductor comprises two subsets of conductors symmetric at the center of the first ½ wavelength resonance electrode, each comprises two ends wherein all ends are connected to ground potential.

10. The bandpass filter according to claim 8, further comprising
an annular ground electrode in the first inter-layer portion, surrounding the first ½ wavelength resonance electrode, the second ½ wavelength resonance electrode, the first ¼ wavelength resonance electrode and the second ¼ wavelength resonance electrode, the third ¼ wavelength resonance electrode, the fourth ¼ wavelength resonance electrode, and connected to the first ground end, the second ground end, the third ground end and the fourth ground end.

11. The bandpass filter according to claim 8, further comprising
a first auxiliary resonance electrode in a second inter-layer portion of the laminate, electrically connected to an area near the fifth open end of the third ¼ wavelength resonance electrode;
a second auxiliary resonance electrode in a second inter-layer portion of the laminate, electrically connected to an area near the sixth open end of the fourth ¼ wavelength resonance electrode;
a third auxiliary resonance electrode in a second inter-layer portion of the laminate, electrically connected to an area near the first open end of the second ½ wavelength resonance electrode;
a fourth auxiliary resonance electrode in a second inter-layer portion of the laminate, electrically connected to an area near the second open end of the second ½ wavelength resonance electrode;
a first auxiliary coupling electrode in a fourth inter-layer portion of the laminate, electrically connected to the first connection point of the first coupling electrode, and facing a part of the first auxiliary resonance electrode;
a second auxiliary coupling electrode in a fourth inter-layer portion of the laminate, electrically connected to the second connection point of the second coupling electrode, and facing a part of the second auxiliary resonance electrode;
a third auxiliary coupling electrode in a fourth inter-layer portion of the laminate, electrically connected to the third connection point of the third coupling electrode, and facing a part of the third auxiliary resonance electrode; and
a fourth auxiliary coupling electrode in a fourth inter-layer portion of the laminate, electrically connected to the fourth connection point of the fourth coupling electrode, and facing a part of the fourth auxiliary resonance electrode,
wherein one of differential signals is inputted into or outputted from between the first coupling electrode and the second coupling electrode, and an external circuit via the first auxiliary coupling electrode and the second auxiliary coupling electrode, and one of differential signals is inputted into or outputted from between the third coupling electrode and the fourth coupling electrode, and an external circuit via the third auxiliary coupling electrode and the fourth auxiliary coupling electrode

12. A wireless communication module, comprising:
a RF module comprising a bandpass filter according to claim 1; and
a base band module connected to the RF module.

13. A wireless communication module, comprising:
a RF module comprising a bandpass filter according to claim 8; and
a base band module connected to the RF module.

14. A wireless communication device, comprising:
a RF module comprising a bandpass filter according to claim 1;
a base band module connected to the RF module; and
an antenna connected to the bandpass filter.

15. A wireless communication device, comprising:
a RF module comprising a bandpass filter according to claim 8;
a base band module connected to the RF module; and
an antenna connected to the bandpass filter.
